(19) United States
(12) Patent Application Publication
(10) Pub. No.: US 2024/0396674 A1
(43) Pub. Date: Nov. 28, 2024

(54) METHOD AND APPARATUS FOR HYBRID AUTOMATIC REPEAT REQUEST IN A NONTERRESTRIAL NETWORK

(71) Applicants: HYUNDAI MOTOR COMPANY, Seoul (KR); KIA CORPORATION, Seoul (KR); INHA UNIVERSITY RESEARCH AND BUSINESS FOUNDATION, Incheon (KR)

(72) Inventors: Young Kil Suh, Hwaseong-si (KR); Gun Hee Moon, Hwaseong-si (KR); Ui Hyun Hong, Hwaseong-si (KR); Gene Back Hahn, Hwaseong-si (KR); Kyu Nam Kim, Hwaseong-si (KR); Duk Kyung Kim, Seoul (KR)

(73) Assignees: HYUNDAI MOTOR COMPANY, Seoul (KR); KIA CORPORATION, Seoul (KR); INHA UNIVERSITY RESEARCH AND BUSINESS FOUNDATION, Incheon (KR)

(21) Appl. No.: 18/798,317

(22) Filed: Aug. 8, 2024

Related U.S. Application Data
(63) Continuation of application No. PCT/KR2023/001897, filed on Feb. 9, 2023.

(30) Foreign Application Priority Data
Feb. 9, 2022 (KR) 10-2022-0016807

(51) Int. Cl. H04L 1/1829; H04L 1/1812

(52) U.S. Cl. CPC H04L 1/1864; H04L 1/1812

(57) ABSTRACT

A method of a terminal in a non-terrestrial network is provided. The method includes receiving first data via a first link between a first satellite and the terminal. The method also includes receiving second data via a second link between a second satellite and the terminal. The method additionally includes determining a long link and a short link on the basis of a first transmission time between the first satellite and the terminal and a second transmission time between the second satellite and the terminal. The method further includes transmitting, via the short link, at least a portion of hybrid automatic repeat request (HARQ) feedback information corresponding to the long link and HARQ feedback information corresponding to the short link.

### CROSS-REFERENCE TO RELATED APPLICATION

This application is a continuation application of International Application No. PCT/KR2023/001897, filed on Feb. 9, 2023, which claims priority from Korean Patent Application No. 10-2022-0016807, filed on Feb. 9, 2022, the disclosures of each of which are incorporated by reference herein in their entirety.

### TECHNICAL FIELD

The present disclosure relates to a hybrid automatic repeat request (HARQ) technique, and more particularly, to a HARQ technique in a non-terrestrial network (NTN).

### BACKGROUND

A communication network (e.g., 5G communication network, 6G communication network, etc.) to provide enhanced communication services compared to the existing communication network (e.g., long term evolution (LTE), LTE-Advanced (LTA-A), etc.) is being developed. The 5G communication network (e.g., new radio (NR) communication network) can support not only a frequency band of 6 GHz or below, but also a frequency band of 6 GHz or above. Accordingly, the 5G communication network can support a frequency range (FR1) band and/or FR2 band. The 5G communication network can support various communication services and scenarios compared to the LTE communication network. For example, usage scenarios of the 5G communication network may include enhanced Mobile BroadBand (eMBB), Ultra Reliable Low Latency Communication (URLLC), Massive Machine Type Communication (mMTC), and the like.

The 6G communication network can support a variety of communication services and scenarios compared to the 5G communication network. The 6G communication networks can meet the requirements of hyper-performance, hyper-bandwidth, hyper-space, hyper-precision, hyper-intelligence, and/or hyper-reliability. The 6G communication networks can support various and wide frequency bands and can be applied to various usage scenarios (e.g., terrestrial communication, non-terrestrial communication, sidelink communication, and the like).

The communication network (e.g., 5G communication network, 6G communication network, etc.) may provide communication services to terminals located on the ground. Recently, the demand for communication services for not only terrestrial but also non-terrestrial airplanes, drones, and satellites has been increasing, and for this purpose, technologies for a non-terrestrial network (NTN) have been discussed. The non-terrestrial network may be implemented based on 5G communication technology, 6G communication technology, and/or the like. For example, in the non-terrestrial network, communication between a satellite and a terrestrial communication node or a non-terrestrial communication node (e.g., airplane, drone, or the like) may be performed based on 5G communication technology, 6G communication technology, and/or the like. In the NTN, the satellite may perform functions of a base station in a communication network (e.g., 5G communication network, 6G communication network, and/or the like).

Recently, techniques to increase link reliability and improve data transmission speed through multiple connections are newly introduced and discussed issues in 5G NR. Unlike a typical terrestrial network (TN) environment, when multiple links are configured in an NTN environment, the degree of latency of each link may be significantly different.

In addition, since HARQ stalling may occur due to a long delay time in the NTN environment, a solution to increase the number of HARQ processes has been proposed, but the latency problem still needs to be resolved. In particular, in LEO/MEO/GEO systems, a difference in delays depending on satellite altitudes is quite large, and therefore, a multi-TRP scenario in the existing TN environment cannot be directly applied to the NTN environment.

### SUMMARY

Embodiments of the present disclosure provide a method and an apparatus for HARQ operations in a non-terrestrial network.

According to an embodiment of the present disclosure, a method of a terminal in a non-terrestrial network is provided. The method includes receiving first data through a first link between a first satellite and the terminal. The method also includes receiving second data through a second link between a second satellite and the terminal. The method additionally includes determining a long link and a short link based on a first transmission time between the first satellite and the terminal and a second transmission time between the second satellite and the terminal. The method further includes transmitting at least part of hybrid automatic repeat request (HARQ) feedback information corresponding to the long link and HARQ feedback information corresponding to the short link through the short link.

The at least part of the HARQ feedback information corresponding to the long link and the HARQ feedback information corresponding to the short link may be transmitted on a first physical uplink control channel (PUCCH1) of the short link.

The PUCCH1 may further include a field for transmitting the HARQ feedback information corresponding to the short link and an additional field for transmitting the at least part of the HARQ feedback information corresponding to the long link.

Whether to configure the additional field for transmitting the at least part of the HARQ feedback information corresponding to the long link may be configured in advance by higher layer signaling.

The method may further include transmitting the HARQ feedback information corresponding to the short link through a PUCCH on the short link; and transmitting the at least part of the HARQ feedback information corresponding to the long link through a preconfigured field in a physical downlink shared channel (PDSCH) on the short link.

The method may further include transmitting the HARQ feedback information corresponding to the short link through a first PUCCH (PUCCH1) on the short link; and transmitting the at least part of the HARQ feedback information corresponding to the long link through a second PUCCH (PUCCH2) on the short link.

The first transmission time may be determined based on a round trip delay (RTD) time from the terminal to the first satellite, and the second transmission time may be determined based on a RTD time from the terminal to the second satellite.

Only HARQ feedback(s) corresponding to pre-configured data among the HARQ feedback information corresponding to the long link may be transmitted through the short link.

The method may further include receiving higher layer signaling including information indicating to alternately transmit HARQ feedbacks through the long link and the short link in units of entire HARQ processes; in response to the higher layer signaling. The method may also include transmitting a HARQ feedback corresponding to a PDSCH received through the long link during one HARQ process through a PUCCH on the long link. The method may additionally include, in response to the higher layer signaling, transmitting a HARQ feedback corresponding to a PDSCH received through the long link during another HARQ process with a same HARQ process identifier as the one HARQ process through a PUCCH on the short link.

According to another embodiment of the present disclosure, a terminal in a non-terrestrial network is provided. The terminal includes at least one processor configured to cause the terminal to receive first data through a first link between a first satellite and the terminal. The at least one processor may also cause the terminal to receive second data through a second link between a second satellite and the terminal. The at least one processor may also cause the terminal to determine a long link and a short link based on a first transmission time between the first satellite and the terminal and a second transmission time between the second satellite and the terminal. The at least one processor may also cause the terminal to transmit at least part of hybrid automatic repeat request (HARQ) feedback information corresponding to the long link and HARQ feedback information corresponding to the short link through the short link.

The at least part of the HARQ feedback information corresponding to the long link and the HARQ feedback information corresponding to the short link may be transmitted on a first physical uplink control channel (PUCCH1) of the short link.

The PUCCH1 may further include a field for transmitting the HARQ feedback information corresponding to the short link and an additional field for transmitting the at least part of the HARQ feedback information corresponding to the long link.

Whether to configure the additional field for transmitting the at least part of the HARQ feedback information corresponding to the long link may be configured in advance by higher layer signaling.

The at least one processor may further cause the terminal to transmit the HARQ feedback information corresponding to the short link through a PUCCH on the short link; and transmitting the at least part of the HARQ feedback information corresponding to the long link through a preconfigured field in a physical downlink shared channel (PDSCH) on the short link.

The at least one processor may further cause the terminal to transmit the HARQ feedback information corresponding to the short link through a first PUCCH (PUCCH1) on the short link. The at least one processor may also cause the terminal to transmit the at least part of the HARQ feedback information corresponding to the long link through a second PUCCH (PUCCH2) on the short link.

The first transmission time may be determined based on a round trip delay (RTD) time from the terminal to the first satellite, and the second transmission time may be determined based on a RTD time from the terminal to the second satellite.

The at least one processor may further cause the terminal transmit only HARQ feedback(s) corresponding to pre-configured data among the HARQ feedback information corresponding to the long link through the short link.

The at least one processor may further cause the terminal to receive higher layer signaling including information indicating to alternately transmit HARQ feedbacks through the long link and the short link in units of entire HARQ processes; in response to the higher layer signaling. The at least one processor may also cause the terminal to transmit a HARQ feedback corresponding to a PDSCH received through the long link during one HARQ process through a PUCCH on the long link The at least one processor may additionally cause the terminal to, in response to the higher layer signaling, transmit a HARQ feedback corresponding to a PDSCH received through the long link during another HARQ process with a same HARQ process identifier as the one HARQ process through a PUCCH on the short link.

In yet another embodiment, a method of a base station in a non-terrestrial network is provided. The method includes transmitting higher layer signaling configuring at least part of i) hybrid automatic repeat request (HARQ) feedback information corresponding to a long link and ii) HARQ feedback information corresponding to a short link to be transmitted through the short link among a first link between a first satellite and the terminal and a second link between a second satellite and the terminal. The method also includes controlling first data to be transmitted through the first link between the first satellite and the terminal. The method further includes controlling second data to be transmitted through the second link between the second satellite and the terminal. The method additionally includes receiving HARQ feedback information corresponding to the first data and HARQ feedback information corresponding to the second data through a satellite of the short link.

The at least part of the HARQ feedback information corresponding to the long link and the HARQ feedback information corresponding to the short link may be transmitted on a first physical uplink control channel (PUCCH1) of the short link.

According to embodiments of the present disclosure, when HARQ feedbacks are transmitted from a terminal establishing links with two or more different satellites operating as multi-TRPs, it is possible to reduce latency and alleviate a HARQ stalling phenomenon. Furthermore, HARQ process identifiers can be reused by transmitting HARQ feedbacks alternately through the respective links. Accordingly, the size of a buffer for data transmission can also be reduced.

### BRIEF DESCRIPTION OF THE DRAWINGS

FIG. 1A is a conceptual diagram illustrating a first embodiment of a non-terrestrial network.

FIG. 1B is a conceptual diagram illustrating a second embodiment of a non-terrestrial network.

FIG. 2A is a conceptual diagram illustrating a third embodiment of a non-terrestrial network.

FIG. 2B is a conceptual diagram illustrating a fourth embodiment of a non-terrestrial network.

FIG. 2C is a conceptual diagram illustrating a fifth embodiment of a non-terrestrial network.

FIG. 3 is a block diagram illustrating a first embodiment of a communication node constituting a non-terrestrial network.

FIG. 4 is a block diagram illustrating a first embodiment of communication nodes performing communication.

FIG. 5A is a block diagram illustrating a first embodiment of a transmission path.

FIG. 5B is a block diagram illustrating a first embodiment of a reception path.

FIG. 6A is a conceptual diagram illustrating a first embodiment of a protocol stack of a user plane in a transparent payload-based non-terrestrial network.

FIG. 6B is a conceptual diagram illustrating a first embodiment of a protocol stack of a control plane in a transparent payload-based non-terrestrial network.

FIG. 7A is a conceptual diagram illustrating a first embodiment of a protocol stack of a user plane in a regenerative payload-based non-terrestrial network.

FIG. 7B is a conceptual diagram illustrating a first embodiment of a protocol stack of a control plane in a regenerative payload-based non-terrestrial network.

FIG. 8 is a conceptual diagram for describing multi-connectivity in a non-terrestrial network environment, according to an embodiment.

FIG. 9 is a conceptual diagram for describing a time at which a HARQ feedback is transmitted in NR, according to an embodiment.

FIG. 10A is a conceptual diagram for describing a HARQ timing in TN, according to an embodiment.

FIG. 10B is a conceptual diagram for describing a HARQ timing in NTN, according to an embodiment.

FIG. 11A is a conceptual diagram for describing a case of using a semi-static Type 1 HARQ codebook, according to an embodiment.

FIG. 11B is a conceptual diagram for describing a case of using a dynamic Type 2 HARQ codebook, according to an embodiment.

FIG. 12 is a conceptual diagram for describing links for communicating with satellites in different orbits according to an embodiment of the present disclosure.

FIG. 13A is a timing diagram for describing a time delay of a signal received from one satellite and transmission of a feedback signal corresponding thereto, according to an embodiment.

FIG. 13B is a conceptual diagram for describing delay times and feedbacks when receiving data from satellites located at different altitudes, according to an embodiment.

FIG. 14A is a conceptual diagram for describing a first method of PUCCH operation according to an embodiment of the present disclosure in an environment where multiple satellites are used as TRPs.

FIG. 14B is a conceptual diagram for describing a second method of PUCCH operation according to an embodiment of the present disclosure in an environment where multiple satellites are used as TRPs.

FIG. 15A is a conceptual timing diagram for describing a method of transmitting HARQ feedback information, according to an embodiment.

FIG. 15B is a diagram for describing cDAI/tDAI when the first link has two CBGs and the second link has one CBG, according to an embodiment.

FIG. 16 is a signal flow diagram for describing a HARQ feedback operation in an environment in which two satellites operate as TRPs, according to an embodiment of the present disclosure.

FIG. 17A is a diagram for describing a HARQ stalling phenomenon occurring when signals are received from a satellite with a long link, according to an embodiment.

FIG. 17B is a timing diagram for describing a case of additionally configuring a HARQ feedback path based on HARQ processes, according to an embodiment.

FIG. 18 is a conceptual diagram for describing a retransmission operation due to a HARQ NACK according to a third embodiment of the present disclosure.

### DETAILED DESCRIPTION

While the present disclosure is capable of various modifications and alternative forms, specific embodiments thereof are shown by way of example in the drawings and are described in detail below. It should be understood, however, that there is no intent to limit the present disclosure to the particular forms disclosed. On the contrary, the present disclosure is intended to cover all modifications, equivalents, and alternatives falling within the spirit and scope of the present disclosure. Like numbers refer to like elements throughout the description of the figures.

It should be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In the present disclosure, “at least one of A and B” may mean “at least one of A or B” or “at least one of combinations of one or more of A and B”. Also, in the present disclosure, “one or more of A and B” may mean “one or more of A or B” or “one or more of combinations of one or more of A and B”.

In the present disclosure, “(re) transmission” may refer to “transmission”, “retransmission”, or “transmission and retransmission”. Further, “(re) configuration” may refer to “configuration”, “reconfiguration”, or “configuration and reconfiguration”. Additionally, “(re) connection” may refer to “connection”, “reconnection”, or “connection and reconnection”. Also, “(re) access” may mean “access”, “re-access”, or “access and re-access”.

It should be understood that when an element is referred to as being “connected” or “coupled” to another element, the element can be directly connected or coupled to the other element or one or more intervening elements may be present between the element and the other element. In contrast, when an element is referred to as being “directly connected” or “directly coupled” to another element, there are no intervening elements present between the element and the other element.

The terminology used herein is for the purpose of describing particular embodiments only and is not intended to be limiting of the present disclosure. As used herein, the singular forms are intended to include the plural forms as well, unless the context clearly indicates otherwise. It should be further understood that the terms “comprise” and/or “include” when used herein, specify the presence of stated features, integers, steps, operations, elements, components or combinations thereof, but do not preclude the presence or addition of one or more other features, integers, steps, operations, elements, components, and/or combinations thereof.

Unless otherwise defined, all terms (including technical and scientific terms) used herein have the same meaning as commonly understood by one of ordinary skill in the art to which this present disclosure pertains. It should be further understood that terms, such as those defined in commonly used dictionaries, should be interpreted as having a meaning that is consistent with their meaning in the context of the relevant art and should not be interpreted in an idealized or overly formal sense unless expressly so defined herein.

When a component, device, element, or the like of the present disclosure is described as having a purpose or performing an operation, function, or the like, the component, device, or element should be considered herein as being “configured to” meet that purpose or perform that operation or function.

Hereinafter, embodiments of the present disclosure are described in detail with reference to the accompanying drawings. In order to facilitate general understanding in describing the present disclosure, the same components in the drawings are denoted with the same reference signs and repeated description thereof has been omitted. In addition to the embodiments explicitly described in the present disclosure, operations may be performed according to a combination of the embodiments, extensions of the described embodiments, and/or modifications of the described embodiments. Performance of some operations may be omitted, and/or the order of performance of operations may be changed.

When a method (e.g., transmission or reception of a signal) performed at a first communication node among communication nodes is described, a corresponding second communication node may perform a method (e.g., reception or transmission of the signal) corresponding to the method performed at the first communication node. For example, when an operation of a user equipment (UE) is described, a base station corresponding to the UE may perform an operation corresponding to the operation of the UE. Conversely, when an operation of a base station is described, a UE corresponding to the base station may perform an operation corresponding to the operation of the base station. In a non-terrestrial network (NTN) (e.g., payload-based NTN), operations of a base station may refer to operations of a satellite, and operations of a satellite may refer to operations of a base station.

The base station may refer to a NodeB, evolved NodeB (eNodeB), next generation node B (gNodeB), gNB, device, apparatus, node, communication node, base transceiver station (BTS), radio remote head (RRH), transmission reception point (TRP), radio unit (RU), roadside unit (RSU), radio transceiver, access point, access node, and/or the like. The UE may refer to a terminal, device, apparatus, node, communication node, end node, access terminal, mobile terminal, station, subscriber station, mobile station, portable subscriber station, on-broad unit (OBU), and/or the like.

In embodiments of the present disclosure, signaling may be at least one of higher layer signaling, medium access control (MAC) signaling, or physical (PHY) signaling. Messages used for higher layer signaling may be referred to as ‘higher layer messages’ or ‘higher layer signaling messages’. Messages used for MAC signaling may be referred to as ‘MAC messages’ or ‘MAC signaling messages’. Messages used for PHY signaling may be referred to as ‘PHY messages’ or ‘PHY signaling messages’. The higher layer signaling may refer to a transmission and reception operation of system information (e.g., master information block (MIB), system information block (SIB)) and/or RRC messages. The MAC signaling may refer to a transmission and reception operation of a MAC control element (CE). The PHY signaling may refer to a transmission and reception operation of control information (e.g., downlink control information (DCI), uplink control information (UCI), and sidelink control information (SCI)).

In embodiments of the present disclosure, “an operation (e.g., transmission operation) is configured” may mean that “configuration information (e.g., information element(s) or parameter(s)) for the operation and/or information indicating to perform the operation is signaled”. “Information element(s) (e.g., parameter(s)) are configured” may mean that “corresponding information element(s) are signaled”. In the present disclosure, “signal and/or channel” may mean a signal, a channel, or “signal and channel,” and “signal” may be used to mean “signal and/or channel”.

A communication system may include at least one of a terrestrial network, non-terrestrial network, 4G communication network (e.g., long-term evolution (LTE) communication network), 5G communication network (e.g., new radio (NR) communication network), or 6G communication network. Each of the 4G communications network, 5G communications network, and 6G communications network may include a terrestrial network and/or a non-terrestrial network. The non-terrestrial network may operate based on at least one communication technology among the LTE communication technology, 5G communication technology, or 6G communication technology. The non-terrestrial network may provide communication services in various frequency bands.

The communication network to which embodiments are applied is not limited to the content described below, and the embodiments may be applied to various communication networks (e.g., 4G communication network, 5G communication network, and/or 6G communication network). A communication network may be used in the same sense as a communication system.

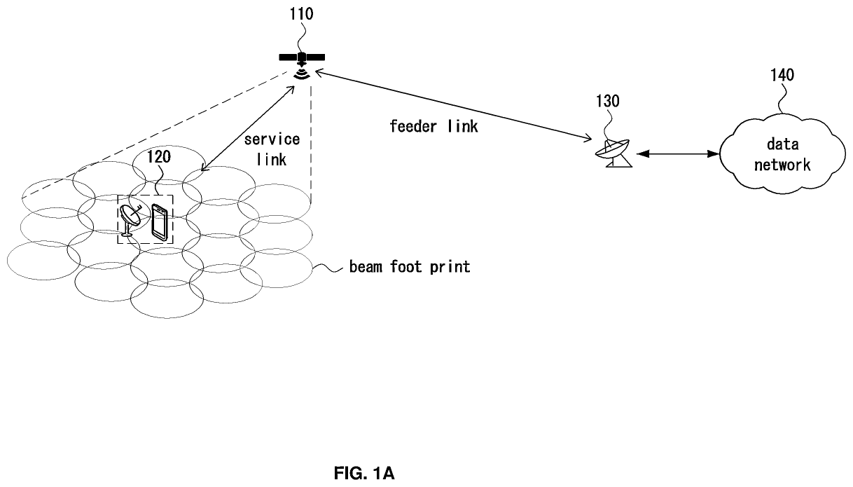

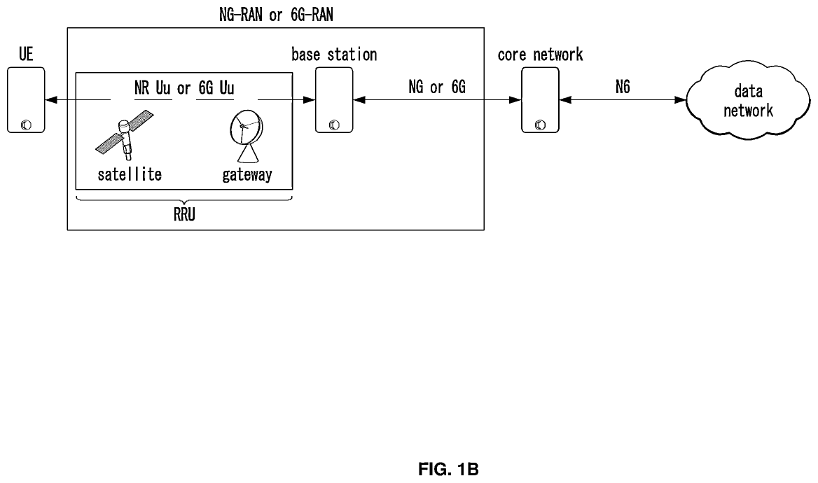

FIG. 1A is a conceptual diagram illustrating a first embodiment of a non-terrestrial network.

As shown in FIG. 1A, a non-terrestrial network (NTN) may include a satellite 110, a communication node 120, a gateway 130, a data network 140, and the like. A unit including the satellite 110 and the gateway 130 may correspond to a remote radio unit (RRU). The NTN shown in FIG. 1A may be an NTN based on a transparent payload. The satellite 110 may be a low earth orbit (LEO) satellite, a medium earth orbit (MEO) satellite, a geostationary earth orbit (GEO) satellite, a high elliptical orbit (HEO) satellite, and/or an unmanned aircraft system (UAS) platform. The UAS platform may include a high altitude platform station (HAPS). A non-GEO satellite may be an LEO satellite and/or MEO satellite.

The communication node 120 may include a communication node (e.g., a user equipment (UE) or a terminal) located on a terrestrial site and/or a communication node (e.g., an airplane, a drone) located on a non-terrestrial space. A service link may be established between the satellite 110 and the communication node 120. The service link may be a radio link, for example. The satellite 110 may provide communication services to the communication node 120 using one or more beams. The shape of a footprint of the beam of the satellite 110 may be elliptical or circular.

In the non-terrestrial network, three types of service links can be supported as follows.

Earth-fixed: a service link may be provided by beam(s) that continuously cover the same geographic area at all times (e.g., geosynchronous orbit (GSO) satellite).

Quasi-earth-fixed: a service link may be provided by beam(s) covering one geographical area during a limited period and provided by beam(s) covering another geographical area during another period (e.g., non-GSO (NGSO) satellite forming steerable beams).

Earth-moving: a service link may be provided by beam(s) moving over the Earth's surface (e.g., NGSO satellite forming fixed beams or non-steerable beams).

The communication node 120 may perform communications (e.g., downlink communication and uplink communication) with the satellite 110 using 4G communication technology, 5G communication technology, and/or 6G communication technology. The communications between the satellite 110 and the communication node 120 may be performed using an NR-Uu interface and/or 6G-Uu interface. When dual connectivity (DC) is supported, the communication node 120 may be connected to other base stations (e.g., base stations supporting 4G, 5G, and/or 6G functionality) as well as the satellite 110 and may perform DC operations based on the techniques defined in 4G, 5G, and/or 6G technical specifications.

The gateway 130 may be located on a terrestrial site, and a feeder link may be established between the satellite 110 and the gateway 130. The feeder link may be a radio link, for example. The gateway 130 may be referred to as a ‘non-terrestrial network (NTN) gateway’. The communications between the satellite 110 and the gateway 130 may be performed based on an NR-Uu interface, a 6G-Uu interface, or a satellite radio interface (SRI). The gateway 130 may be connected to the data network 140. There may be a ‘core network’ between the gateway 130 and the data network 140. For example, the gateway 130 may be connected to the core network, and the core network may be connected to the data network 140. The core network may support the 4G communication technology, 5G communication technology, and/or 6G communication technology. For example, the core network may include an access and mobility management function (AMF), a user plane function (UPF), a session management function (SMF), and the like. The communications between the gateway 130 and the core network may be performed based on an NG-C/U interface or 6G-C/U interface.

As shown in FIG. 1B, there may be a ‘core network’ between the gateway 130 and the data network 140 in a transparent payload-based NTN, in an embodiment.

FIG. 1B is a conceptual diagram illustrating a second embodiment of a non-terrestrial network.

As shown in FIG. 1B, the gateway may be connected with the base station, the base station may be connected with the core network, and the core network may be connected with the data network. Each of the base station and core network may support the 4G communication technology, 5G communication technology, and/or 6G communication technology. The communications between the gateway and the base station may be performed based on an NR-Uu interface or 6G-Uu interface. The communications between the base station and the core network (e.g., AMF, UPF, SMF, and/or the like) may be performed based on an NG-C/U interface or 6G-C/U interface.

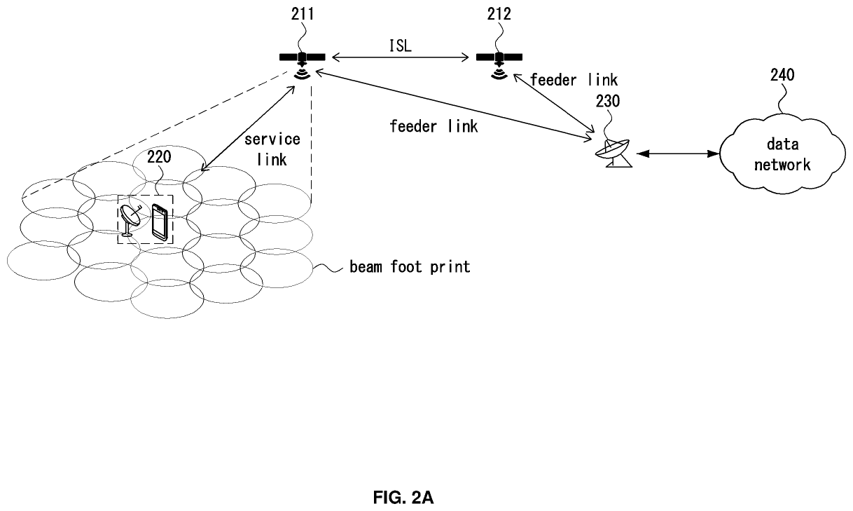

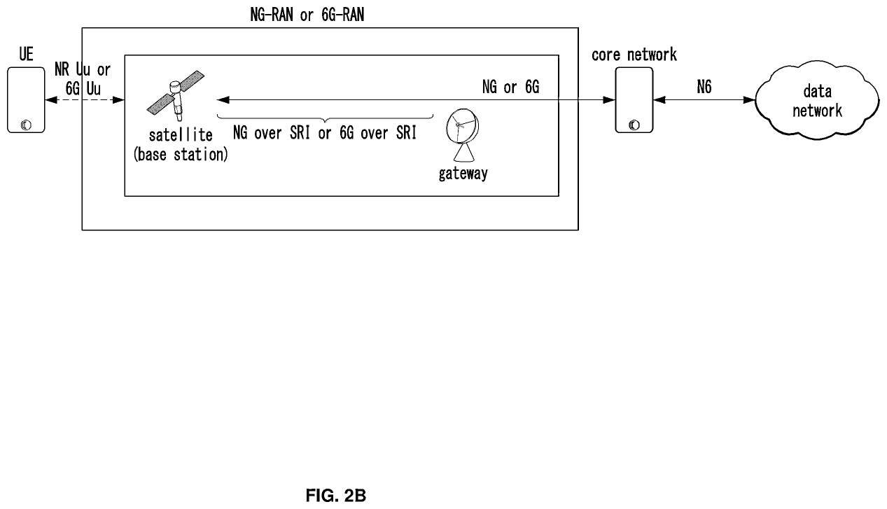

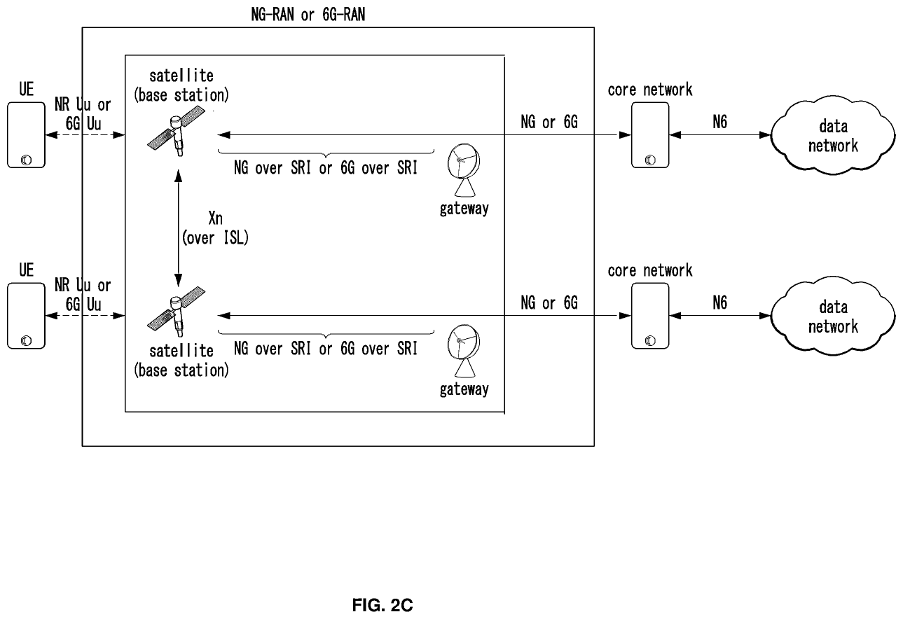

FIG. 2A is a conceptual diagram illustrating a third embodiment of a non-terrestrial network.

As shown in FIG. 2A, a non-terrestrial network may include a first satellite 211, a second satellite 212, a communication node 220, a gateway 230, a data network 240, and the like. The NTN shown in FIG. 2A may be a regenerative payload based NTN. For example, each of the satellites 211 and 212 may perform a regenerative operation (e.g., demodulation, decoding, re-encoding, re-modulation, and/or filtering operation) on a payload received from other entities (e.g., the communication node 220 or the gateway 230) and may transmit the regenerated payload.

Each of the satellites 211 and 212 may be a LEO satellite, a MEO satellite, a GEO satellite, a HEO satellite, or a UAS platform. The UAS platform may include a HAPS. The satellite 211 may be connected to the satellite 212. An inter-satellite link (ISL) may be established between the satellite 211 and the satellite 212. The ISL may operate in an RF frequency band or an optical band. The ISL may be established optionally. The communication node 220 may include a terrestrial communication node (e.g., UE or terminal) and/or a non-terrestrial communication node (e.g., airplane or drone). A service link (e.g., radio link) may be established between the satellite 211 and communication node 220. The satellite 211 may provide communication services to the communication node 220 using one or more beams.

The communication node 220 may perform communications (e.g., downlink communication or uplink communication) with the satellite 211 using the 4G communication technology, 5G communication technology, and/or 6G communication technology. The communications between the satellite 211 and the communication node 220 may be performed using an NR-Uu interface or 6G-Uu interface. When DC is supported, the communication node 220 may be connected to other base stations (e.g., base stations supporting 4G, 5G, and/or 6G functionality) as well as the satellite 211. The communication node 220 may perform DC operations based on the techniques defined in 4G, 5G, and/or 6G technical specifications.

The gateway 230 may be located on a terrestrial site. A feeder link may be established between the satellite 211 and the gateway 230. Also, a feeder link may be established between the satellite 212 and the gateway 230. The feeder link may be a radio link, for example. When the ISL is not established between the satellite 211 and the satellite 212, the feeder link between the satellite 211 and the gateway 230 may be established mandatorily. The communications between each of the satellites 211 and 212 and the gateway 230 may be performed based on an NR-Uu interface, a 6G-Uu interface, or an SRI. The gateway 230 may be connected to the data network 240.

As shown in FIGS. 2B and 2C, there may be a ‘core network’ between the gateway 230 and the data network 240, in an embodiment.

FIG. 2B is a conceptual diagram illustrating a fourth embodiment of a non-terrestrial network, and FIG. 2C is a conceptual diagram illustrating a fifth embodiment of a non-terrestrial network.

As shown in FIG. 2B and FIG. 2C, the gateway may be connected with the core network, and the core network may be connected with the data network. The core network may support the 4G communication technology, 5G communication technology, and/or 6G communication technology. The core network may include AMF, UPF, SMF, and/or the like. Communication between the gateway and the core network may be performed based on an NG-C/U interface or 6G-C/U interface. Functions of a base station may be performed by the satellite. In other words, the base station may be located on the satellite. A payload may be processed by the base station located on the satellite. Base stations located on different satellites may be connected to the same core network. One satellite may have one or more base stations. In the non-terrestrial network of FIG. 2B, an ISL between satellites may not be established. In the non-terrestrial network of FIG. 2C, an ISL between satellites may be established.

The entities (e.g., satellite, base station, UE, communication node, gateway, and the like) constituting the non-terrestrial network shown in FIGS. 1A, 1B, 2A, 2B, and/or 2C may be configured as follows. In the present disclosure, the entity may be referred to as a communication node.

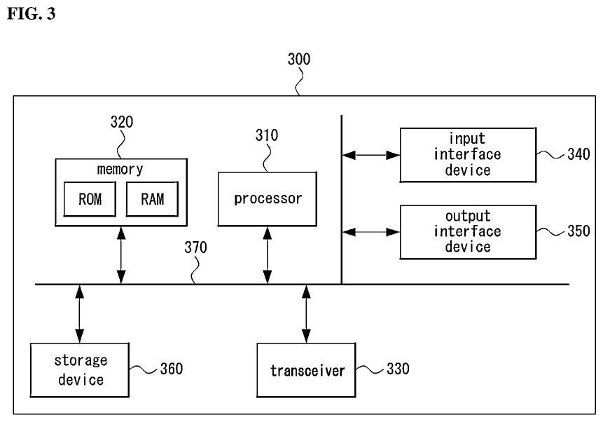

FIG. 3 is a block diagram illustrating a first embodiment of a communication node constituting a non-terrestrial network.

As shown in FIG. 3, a communication node 300 may include at least one processor 310, a memory 320, and a transceiver 330 connected to a network to perform communication. In addition, the communication node 300 may further include an input interface device 340, an output interface device 350, a storage device 360, and/or the like. The components included in the communication node 300 may be connected by a bus 370 to communicate with each other.

However, each component included in the communication node 300 may be connected to the processor 310 through a separate interface or a separate bus instead of the common bus 370. For example, the processor 310 may be connected to at least one of the memory 320, the transceiver 330, the input interface device 340, the output interface device 350, and the storage device 360 through a dedicated interface.

The processor 310 may execute at least one instruction stored in at least one of the memory 320 and the storage device 360. The processor 310 may refer to a central processing unit (CPU), a graphics processing unit (GPU), or a dedicated processor on which the methods according to embodiments of the present disclosure may be performed. Each of the memory 320 and the storage device 360 may be configured as at least one of a volatile storage medium and/or a nonvolatile storage medium. For example, the memory 320 may be configured with at least one of a read only memory (ROM) and/or a random access memory (RAM).

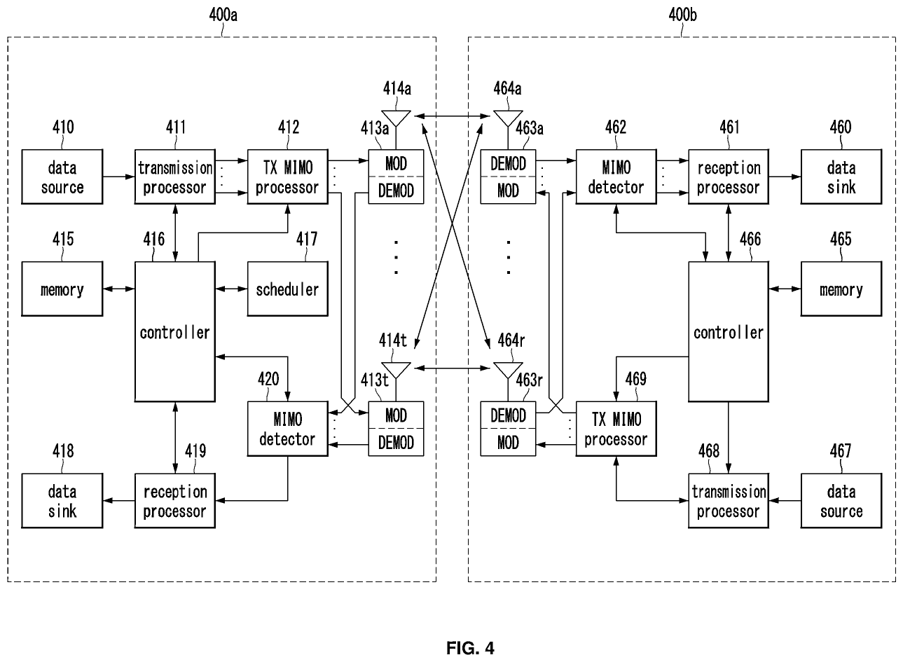

In embodiments, communication nodes that perform communications in the communication network (e.g., non-terrestrial network) may be configured as follows. A communication node shown in FIG. 4 may correspond to the communication node shown in FIG. 3, in an embodiment.

FIG. 4 is a block diagram illustrating a first embodiment of communication nodes performing communication.

As shown in FIG. 4, each of a first communication node 400a and a second communication node 400b may be a base station or UE. The first communication node 400a may transmit a signal to the second communication node 400b. A transmission processor 411 included in the first communication node 400a may receive data (e.g., a data unit) from a data source 410. The transmission processor 411 may receive control information from a controller 416. The control information may include at least one of system information, RRC configuration information (e.g., information configured by RRC signaling), MAC control information (e.g., MAC CE), or PHY control information (e.g., DCI, SCI).

The transmission processor 411 may generate data symbol(s) by performing processing operations (e.g., encoding operation, symbol mapping operation, etc.) on the data. The transmission processor 411 may generate control symbol(s) by performing processing operations (e.g., encoding operation, symbol mapping operation, etc.) on the control information. In addition, the transmission processor 411 may generate synchronization/reference symbol(s) for synchronization signals and/or reference signals.

A Tx MIMO processor 412 may perform spatial processing operations (e.g., precoding operations) on the data symbol(s), control symbol(s), and/or synchronization/reference symbol(s). An output (e.g., a symbol stream) of the Tx MIMO processor 412 may be provided to modulators (MODs) included in transceivers 413a to 413t. The modulator may generate modulation symbols by performing processing operations on the symbol stream, and may generate signals by performing additional processing operations (e.g., analog conversion operations, amplification operation, filtering operation, up-conversion operation, etc.) on the modulation symbols. The signals generated by the modulators of the transceivers 413a to 413t may be transmitted through antennas 414a to 414t.

The signals transmitted by the first communication node 400a may be received at antennas 464a to 464r of the second communication node 400b. The signals received at the antennas 464a to 464r may be provided to demodulators (DEMODs) included in transceivers 463a to 463r. The demodulator (DEMOD) may obtain samples by performing processing operations (e.g., filtering operation, amplification operation, down-conversion operation, digital conversion operation, etc.) on the signals. The demodulator may perform additional processing operations on the samples to obtain symbols. A MIMO detector 462 may perform MIMO detection operations on the symbols. A reception processor 461 may perform processing operations (e.g., de-interleaving operation, decoding operation, etc.) on the symbols. An output of the reception processor 461 may be provided to a data sink 460 and a controller 466. For example, the data may be provided to the data sink 460 and the control information may be provided to the controller 466.

On the other hand, the second communication node 400b may transmit signals to the first communication node 400a. A transmission processor 469 included in the second communication node 400b may receive data (e.g., a data unit) from a data source 467 and perform processing operations on the data to generate data symbol(s). The transmission processor 468 may receive control information from the controller 466 and perform processing operations on the control information to generate control symbol(s). In addition, the transmission processor 468 may generate reference symbol(s) by performing processing operations on reference signals.

A Tx MIMO processor 469 may perform spatial processing operations (e.g., precoding operations) on the data symbol(s), control symbol(s), and/or reference symbol(s). An output (e.g., a symbol stream) of the Tx MIMO processor 469 may be provided to modulators (MODs) included in the transceivers 463a to 463t. The modulator may generate modulation symbols by performing processing operations on the symbol stream, and may generate signals by performing additional processing operations (e.g., analog conversion operation, amplification operation, filtering operation, up-conversion operations) on the modulation symbols. The signals generated by the modulators of the transceivers 463a to 463t may be transmitted through the antennas 464a to 464t.

The signals transmitted by the second communication node 400b may be received at the antennas 414a to 414r of the first communication node 400a. The signals received at the antennas 414a to 414r may be provided to demodulators (DEMODs) included in the transceivers 413a to 413r. The demodulator may obtain samples by performing processing operations (e.g., filtering operation, amplification operation, down-conversion operation, digital conversion operation) on the signals. The demodulator may perform additional processing operations on the samples to obtain symbols. A MIMO detector 420 may perform a MIMO detection operation on the symbols. The reception processor 419 may perform processing operations (e.g., de-interleaving operation, decoding operation, etc.) on the symbols. An output of the reception processor 419 may be provided to a data sink 418 and the controller 416. For example, the data may be provided to the data sink 418 and the control information may be provided to the controller 416.

Memories 415 and 465 may store the data, control information, and/or program codes. A scheduler 417 may perform scheduling operations for communication. The processors 411, 412, 419, 461, 468, and 469 and the controllers 416 and 466 shown in FIG. 4 may correspond to the processor 310 shown in FIG. 3 and may be used to perform methods according to embodiments of the present disclosure.

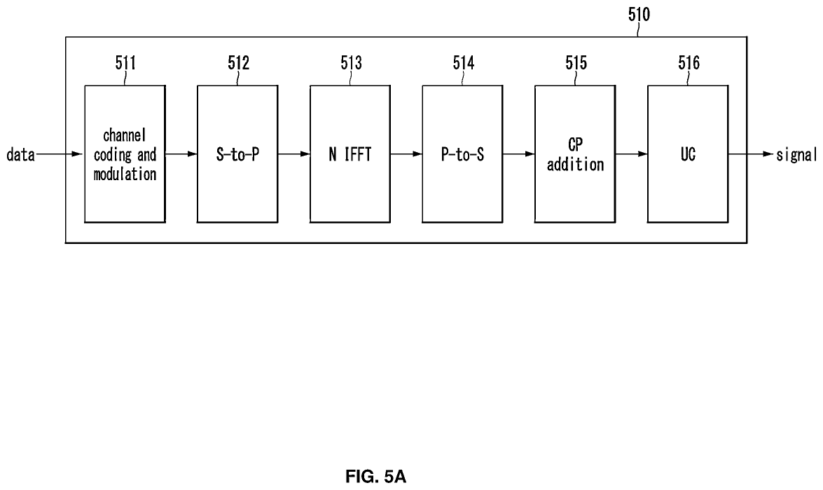

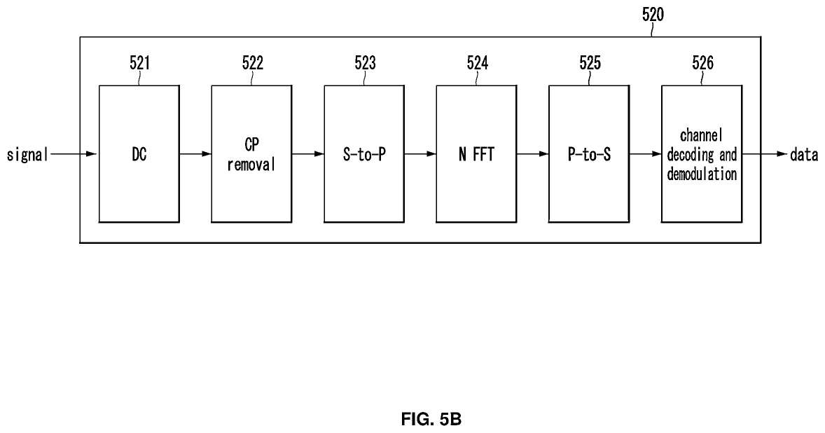

FIG. 5A is a block diagram illustrating a first embodiment of a transmission path. FIG. 5B is a block diagram illustrating a first embodiment of a reception path.

As shown in FIGS. 5A and 5B, a transmission path 510 may be implemented in a communication node that transmits signals, and a reception path 520 may be implemented in a communication node that receives signals. The transmission path 510 may include a channel coding and modulation block 511, a serial-to-parallel (S-to-P) block 512, an N-point inverse fast Fourier transform (N-point IFFT) block 513, a parallel-to-serial (P-to-S) block 514, a cyclic prefix (CP) addition block 515, and up-converter (UC) 516. The reception path 520 may include a down-converter (DC) 521, a CP removal block 522, an S-to-P block 523, an N-point FFT block 524, a P-to-S block 525, and a channel decoding and demodulation block 526. Here, N may be a natural number.

In the transmission path 510, information bits may be input to the channel coding and modulation block 511. The channel coding and modulation block 511 may perform a coding operation (e.g., low-density parity check (LDPC) coding operation, polar coding operation, etc.) and a modulation operation (e.g., Quadrature Phase Shift Keying (OPSK), Quadrature Amplitude Modulation (QAM), etc.) on the information bits. An output of the channel coding and modulation block 511 may be a sequence of modulation symbols.

The S-to-P block 512 may convert frequency domain modulation symbols into parallel symbol streams to generate N parallel symbol streams. N may be the IFFT size or the FFT size. The N-point IFFT block 513 may generate time domain signals by performing an IFFT operation on the N parallel symbol streams. The P-to-S block 514 may convert the output (e.g., parallel signals) of the N-point IFFT block 513 to serial signals to generate the serial signals.

The CP addition block 515 may insert a CP into the signals. The UC 516 may up-convert a frequency of the output of the CP addition block 515 to a radio frequency (RF) frequency. Further, the output of the CP addition block 515 may be filtered in baseband before the up-conversion.

The signal transmitted from the transmission path 510 may be input to the reception path 520. Operations in the reception path 520 may be reverse operations of the operations in the transmission path 510. The DC 521 may down-convert a frequency of the received signals to a baseband frequency. The CP removal block 522 may remove a CP from the signals. The output of the CP removal block 522 may be serial signals. The S-to-P block 523 may convert the serial signals into parallel signals. The N-point FFT block 524 may generate N parallel signals by performing an FFT algorithm. The P-to-S block 525 may convert the parallel signals into a sequence of modulation symbols. The channel decoding and demodulation block 526 may perform a demodulation operation on the modulation symbols and may restore data by performing a decoding operation on a result of the demodulation operation.

In FIGS. 5A and 5B, discrete Fourier transform (DFT) and inverse DFT (IDFT) may be used instead of FFT and IFFT. Each of the blocks (e.g., components) in FIGS. 5A and 5B may be implemented by at least one of hardware, software, or firmware. For example, some blocks in FIGS. 5A and 5B may be implemented by software, and other blocks may be implemented by hardware or a combination of hardware and software. In FIGS. 5A and 5B, one block may be subdivided into a plurality of blocks, a plurality of blocks may be integrated into one block, some blocks may be omitted, and blocks supporting other functions may be added.

NTN reference scenarios may be defined as shown in Table 1 below.

TABLE 1

| | NTN shown | NTN shown |
|---|---|---|
| | in FIG. 1 | in FIG. 2 |
| GEO | Scenario A | Scenario B |
| LEO (steerable | Scenario C1 | Scenario D1 |
| beams) | | |
| LEO (beams | Scenario C2 | Scenario D2 |
| moving with | | |
| satellite) | | |

When the satellite 110 in the NTN shown in FIG. 1A and/or FIG. 1B is a GEO satellite (e.g., a GEO satellite that supports a transparent function), this may be referred to as ‘scenario A’. When the satellites 211 and 212 in the NTN shown in FIG. 2A, FIG. 2B, and/or FIG. 2C are GEO satellites (e.g., GEOs that support a regenerative function), this may be referred to as ‘scenario B’. When the satellite 110 in the NTN shown in FIG. 1A and/or FIG. 1B is an LEO satellite with steerable beams, this may be referred to as ‘scenario C1’. When the satellite 110 in the NTN shown in FIG. 1A and/or FIG. 1B is an LEO satellite having beams moving with the satellite, this may be referred to as ‘scenario C2’. When the satellites 211 and 212 in the NTN shown in FIG. 2A, FIG. 2B, and/or FIG. 2C are LEO satellites with steerable beams, this may be referred to as ‘scenario D1’. When the satellites 211 and 212 in the NTN shown in FIG. 2A, FIG. 2B, and/or FIG. 2C are LEO satellites having beams moving with the satellites, this may be referred to as ‘scenario D2’.

Parameters for the NTN reference scenarios defined in Table 1, according to embodiments, may be defined as shown in Table 2 below.

TABLE 2

| | Scenarios A and B | Scenarios C and D |
|---|---|---|
| Altitude | 35,786 kilometers (km) | 600 km |
| | | 1,200 km |
| Spectrum | <6 GHz (e.g., 2 GHz) | |
| (service link) | >6 GHz (e.g., DL 20 GHz, UL 30 GHz) | |
| Maximum channel | 30 MHz for band <6 GHz | |
| bandwidth capability | 1 GHz for band >6 GHz | |
| (service link) | | |
| Maximum distance | 40,581 km | 1,932 km (altitude of 600 km) |
| between satellite and | | 3,131 km (altitude of 1,200 km) |
| communication node (e.g., | | |
| UE) at the minimum | | |
| elevation angle | | |
| Maximum round trip | Scenario A: 541.46 | Scenario C: (transparent |
| delay (RTD) | milliseconds (ms) | payload: service and |
| (only propagation delay) | (service and feeder links) | feeder links) |
| | Scenario B: 270.73 ms | −5.77 ms (altitude of 600 km) |
| | (only service link) | −41.77 ms (altitude of 1,200 km) |
| | | Scenario D: (regenerative |
| | | payload: only service link) |
| | | −12.89 ms (altitude of 600 km) |
| | | −20.89 ms (altitude of 1,200 km) |
| Maximum differential | 10.3 ms | 3.12 ms (altitude of 600 km) |
| delay within a cell | | 3.18 ms (altitude of 1,200 km) |

| | |
|---|---|
| Service link | NR defined in 3GPP |
| Feeder link | Radio interfaces defined in 3GPP or non-3GPP |

In addition, in the scenarios defined in Table 1, delay constraints may be defined as shown in Table 3 below.

TABLE 3

| | Scenario A | Scenario B | Scenario C1-2 | Scenario D1-2 |
|---|---|---|---|---|
| Satellite altitude | 35,786 km | | 600 km | |
| Maximum RTD in a | 541.75 ms | 270.57 ms | 28.41 ms | 12.88 ms |
| radio interface | (worst case) | | | |
| between base station | | | | |
| and UE | | | | |
| Minimum RTD in a | 477.14 ms | 238.57 ms | 8 ms | 4 ms |
| radio interface | | | | |
| between base station | | | | |
| and UE | | | | |

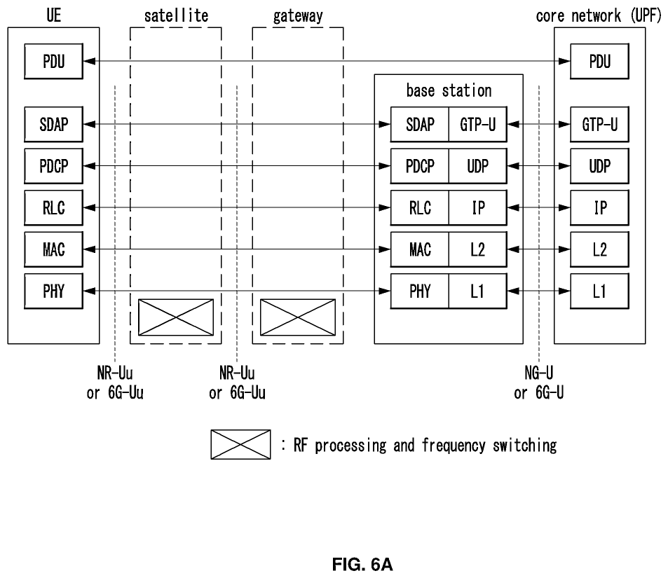

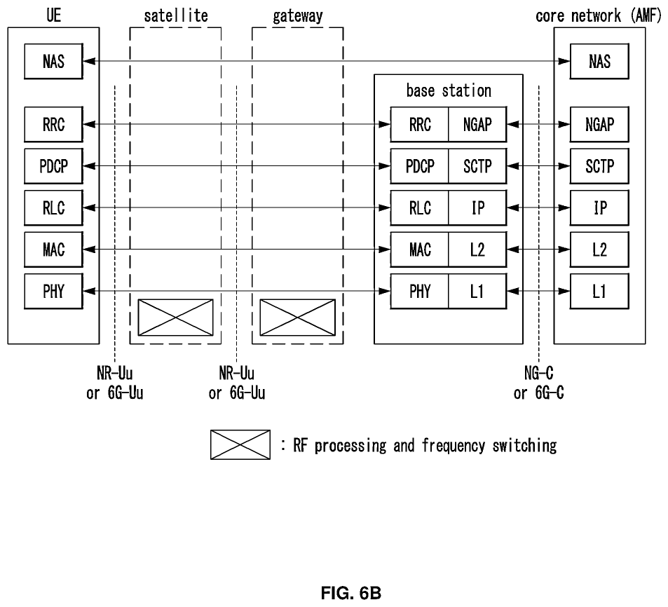

FIG. 6A is a conceptual diagram illustrating a first embodiment of a protocol stack of a user plane in a transparent payload-based non-terrestrial network. FIG. 6B is a conceptual diagram illustrating a first embodiment of a protocol stack of a control plane in a transparent payload-based non-terrestrial network.

As shown in FIGS. 6A and 6B, user data may be transmitted and received between a UE and a core network (e.g., UPF), and control data (e.g., control information) may be transmitted and received between the UE and the core network (e.g., AMF). Each of the user data and the control data may be transmitted and received through a satellite and/or gateway. The protocol stack of the user plane shown in FIG. 6A may be applied identically or similarly to a 6G communication network. The protocol stack of the control plane shown in FIG. 6B may be applied identically or similarly to a 6G communication network.

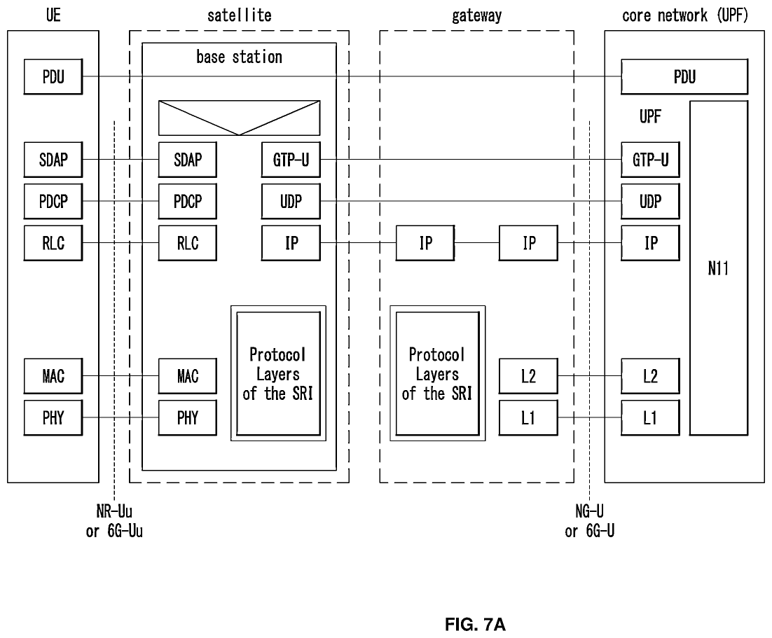

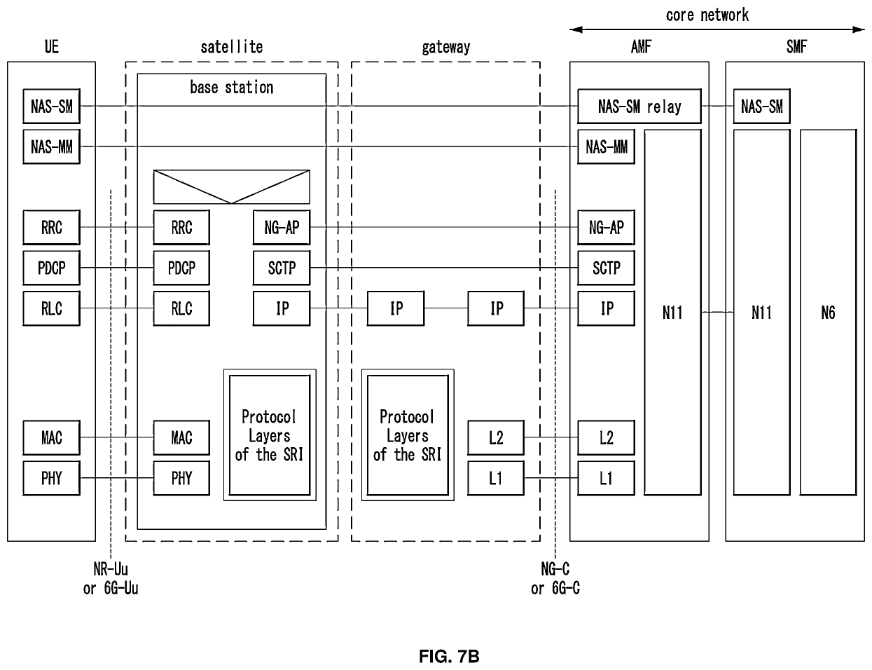

FIG. 7A is a conceptual diagram illustrating a first embodiment of a protocol stack of a user plane in a regenerative payload-based non-terrestrial network. FIG. 7B is a conceptual diagram illustrating a first embodiment of a protocol stack of a control plane in a regenerative payload-based non-terrestrial network.

As shown in FIGS. 7A and 7B, each of user data and control data (e.g., control information) may be transmitted and received through an interface between a UE and a satellite (e.g., base station). The user data may refer to a user protocol data unit (PDU). A protocol stack of a satellite radio interface (SRI) may be used to transmit and receive the user data and/or control data between the satellite and a gateway. The user data may be transmitted and received through a general packet radio service (GPRS) tunneling protocol (GTP)-U tunnel between the satellite and a core network.

In a non-terrestrial network, a base station may transmit system information (e.g., SIB19) including satellite assistance information for NTN access. A UE may receive the system information (e.g., SIB19) from the base station, identify the satellite assistance information included in the system information, and perform communication (e.g., non-terrestrial communication) based on the satellite assistance information. The SIB 19 may include information element(s) defined in Table 4 below.

TABLE 4
SIB19-r17 ::= SEQUENCE {

| | |
|---|---|
| ntn-Config-r17 | NTN-Config-r17 |
| t-Service-r17 | INTEGER(0..549755813887) |
| referenceLocation-r17 | ReferenceLocation-r17 |
| distanceThresh-r17 | INTEGER(0..65525) |

| | |
|---|---|
| ntn-NeighCellConfigList-r17 | NTN-NeighCellConfigList-r17 |
| lateNonCriticalExtension | OCTET STRING |

```
  ...,
  [[
```

| | |
|---|---|
| ntn-NeighCellConfigListExt-v1720 | NTN-NeighCellConfigList-r17 |

]]
}

| | |
|---|---|
| NTN-NeighCellConfigList-r17 ::= | SEQUENCE (SIZE(1..maxCellNTN-r17)) OF |

NTN-NeighCellConfig-r17

| | |
|---|---|
| NTN-NeighCellConfig-r17 ::= | SEQUENCE { |

| | |
|---|---|
| ntn-Config-r17 | NTN-Config-r17 |
| carrierFreq-r17 | ARFCN-ValueNR |
| physCellId-r17 | PhysCellId |

}

NTN-Config defined in Table 4 may include information element(s) defined in Table 5 below.

TABLE 5

| | |
|---|---|
| NTN-Config-r17 ::= | SEQUENCE { |
| epochTime-r17 | EpochTime-r17 |

ntn-UlSyncValidityDuration-r17 ENUMERATED{ s5, s10, s15, s20, s25, s30, s35, s40,
s45, s50, s55, s60, s120, s180, s240, s900}

| | |
|---|---|
| cellSpecificKoffset-r17 | INTEGER(1..1023) |
| kmac-r17 | INTEGER(1..512) |
| ta-Info-r17 | TA-Info-r17 |
| ntn-PolarizationDL-r17 | ENUMERATED {rhcp,lhcp,linear} |
| ntn-PolarizationUL-r17 | ENUMERATED {rhcp,lhcp,linear} |
| ephemerisInfo-r17 | EphemerisInfo-r17 |
| ta-Report-r17 | ENUMERATED {enabled} |

...
}

| | |
|---|---|
| EpochTime-r17 ::= | SEQUENCE { |

| | |
|---|---|
| sfn-r17 | INTEGER(0..1023), |

| | |
|---|---|
| subFrameNR-r17 | INTEGER(0..9) |

}

| | |
|---|---|
| TA-Info-r17 ::= | SEQUENCE { |
| ta-Common-r17 | INTEGER(0..66485757), |
| ta-CommonDrift-r17 | INTEGER(−257303..257303) |

| | |
|---|---|
| ta-CommonDriftVariant-r17 | INTEGER(0..28949) |

}

EphemerisInfo defined in Table 5 may include information element(s) defined in Table 6 below.

TABLE 6

| | |
|---|---|
| EphemerisInfo-r17 ::= | CHOICE { |
| positionVelocity-r17 | PositionVelocity-r17, |
| orbital-r17 | Orbital-r17 |

}

| | |
|---|---|
| PositionVelocity-r17 ::= | SEQUENCE { |
| positionX-r17 | PositionStateVector-r17, |
| positionY-r17 | PositionStateVector-r17, |
| positionZ-r17 | PositionStateVector-r17, |
| velocity VX-r17 | VelocityStateVector-r17, |
| velocity VY-r17 | VelocityStateVector-r17, |
| velocity VZ-r17 | VelocityStateVector-r17 |

}

| | |
|---|---|
| Orbital-r17 ::= | SEQUENCE { |
| semiMajorAxis-r17 | INTEGER |
| | (0..8589934591), |
| eccentricity-r17 | INTEGER (0..1048575), |
| periapsis-r17 | INTEGER (0..268435455), |
| longitude-r17 | INTEGER (0..268435455), |
| inclination-r17 | INTEGER (−67108864..67108863), |
| meanAnomaly-r17 | INTEGER |
| | (0..268435455) |

}
PositionStateVector-r17 ::= INTEGER (−33554432..33554431)
VelocityStateVector-r17 ::= INTEGER (−131072..131071)

Techniques to increase link reliability and improve data transmission speed through multiple connections are newly introduced and discussed issues in 5G NR. Unlike a typical TN environment, when multiple links are configured in an NTN environment, the degree of latency of each link may be significantly different. In addition, since HARQ stalling may occur due to a long delay time in the NTN environment, a solution to increase the number of HARQ processes has been proposed. However, the latency problem still needs to be resolved. In particular, in LEO/MEO/GEO systems, a difference in delays depending on satellite altitudes is quite large, and therefore, a multi-TRP scenario in the existing TN environment cannot be directly applied to the NTN environment.

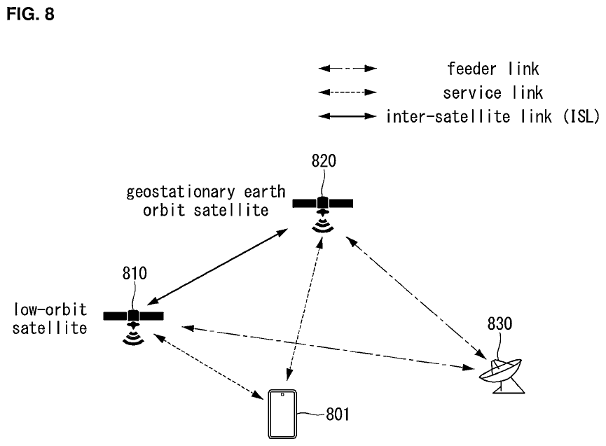

FIG. 8 is a conceptual diagram for describing multi-connectivity in a non-terrestrial network environment.

As shown in FIG. 8, two different satellites 810 and 820 are illustrated. The first satellite 810 may be a low-orbit satellite, for example, a LEO satellite. The second satellite 820 may be a geostationary earth orbit (GEO) satellite. It should be noted that FIG. 8 shows merely an example of two different satellites having different orbits, and that the present disclosure described below is not limited to a LEO satellite and a GEO satellite. In addition, the two different satellites may be satellites respectively having a short link and a long link with a terminal due to different distances from the terminal, even when they are satellites in the same orbit rather than satellites in different orbits. However, in the following description, for convenience of description, the satellites are described as a low-orbit satellite and a GEO satellite as an example. In addition, it is assumed that the satellites described in the present disclosure are transparent payload-based NTN satellites or bent-pipe satellites that do not process data as described above.

A communication node 801 establishing service links with the different satellites 810 and 820 is illustrated. The communication node 801 may be a UE or a various type of communication device carried by a user. Therefore, for convenience of description, it is collectively referred to as a terminal 801 in the following description.

In addition, in the NTN system, each of the satellites 810 and 820 may be connected to a gateway 830 through a feeder link. The satellites 810 and 820 may be connected to base station(s) and/or to a core network through the gateway. In FIG. 8, configuration of connections after the gateway is omitted.

The need for researches on multi-connectivity is being raised by many companies participating in the 3GPP Rel 18 NTN standardization meeting. What is being proposed by the respective companies is follows.

Among companies participating in the 3GPP standardization, Samsung Electronics is proposing mobility management by a satellite that provides continuous connectivity. For example, a GEO satellite may become an anchor node, and before constructing constellation of LEO satellites, a very limited number of LEO satellites may provide better links for data transmission.

LG Electronics is proposing various multi-connectivity NTN scenarios considering connectivity in which LEO satellites participate, connectivity in which a GEO satellite and a LEO satellite participate, and connectivity in which a TN and an NTN participate. FGI and APT are proposing that TN/NTN connectivity should be supported in the 3GPP Release 18, and CATT is proposing that TN/NTN connectivity or LEO/GEO connectivity should be considered.

[Multiple Transmit and Receive Point (mTRP) Operation Scheme]

5G multi-TRP transmission may be classified into an ideal backhaul case and a non-ideal backhaul case depending on a type of backhaul. This classification is defined in the 3GPP standardization as follows.

A backhaul with a one-way latency of less than 2.5 microseconds (us) and a throughput of up to 10 Gbps may be referred to as an ideal backhaul. On the other hand, a backhaul with a one-way latency of 2 to 60 milliseconds (ms) and a throughput of 10 Mbps to 10 Gbps may be referred to as a non-ideal backhaul.

In case of using an ideal backhaul in multi-TRP transmission, joint transmission and reception is possible because there are no synchronization problems on multiple links. However, in case of using a non-ideal backhaul, non-coherent joint transmission may be supported. In case of an ideal backhaul, or even in case of a non-ideal backhaul with a sufficiently small required capacity and latency, coherent joint transmission between synchronized TRPs may be possible. The coherent joint transmission schemes between synchronized TRPs may include coordinated beamforming and dynamic point selection (DPS) schemes. Therefore, in the coherent joint transmission scheme between synchronized TRPs, joint scheduling for multiple downlinks may be possible. On the other hand, when transmitting data using multiple TRPs, non-coherent joint transmission is possible if a non-ideal backhaul is used. During non-coherent joint transmission using multiple TRPs, each TRP link may be scheduled independently without exchanging channel state information (CSI) and scheduling information between TRPs.

A terminal that receives data through downlink channels from multiple TRPs may transmit HARQ feedbacks signal through respective uplinks. For example, the terminal may transmit a HARQ positive response (i.e., acknowledgement (ACK)) or a HARQ negative response (i.e., negative ACK (NACK)) as a HARQ feedback transmitted through the uplink. When the terminal transmits the HARQ feedback signal through the uplink channel, each HARQ feedback may be transmitted through an independent uplink control channel for each TRP, or the HARQ feedbacks may be transmitted through a one joint uplink control channel. When the terminal transmits the HARQ feedbacks through the one joint uplink control channel, ACK(s)/NACK(s) for the data received from the different TRPs may be transmitted as being multiplexed.

When the terminal transmits HARQ feedbacks using a joint uplink control channel, the feedbacks may be transmitted to one specific TRP. Therefore, a TRP that transmits downlink data and does not receive the joint uplink control channel may need to receive the HARQ feedback from the TRP that receives the joint uplink control channel. In this case, in case of using a non-ideal backhaul, a latency may occur in delivery of the HARQ feedback. A latency in the non-ideal backhaul link may occur in the process of delivering the HARQ feedback from the TRP receiving the HARQ feedback to another TRP.

### [Harq Timing]

According to the 3GPP LTE technical specifications, a timing between a data transmission and a HARQ feedback is fixed. According to the LTE technical specifications, a HARQ response timing requirement for an FDD scheme suitable for application to the NTN environment is 3 ms, and a somewhat complicated scheme is applied to a TDD scheme depending on an uplink/downlink configuration (i.e., TDD configuration).

According to the 3GPP NR technical specifications, also known as 5G communication, a timing between a data transmission and a HARQ feedback may be determined flexibly compared to the LTE, based on a combination of DCI and RRC. More specifically, according to the 3GPP NR technical specifications, a table with multiple timings available between a data transmission and a HARQ feedback may be defined through an RRC message, and an index of an entry in the table defined by the RRC message may be indicated by a 3-bit pointer included in DCI.

Parameters used for controlling the HARQ timing in the 3GPP NR technical specifications include K₀ and K₁, and these are each defined as follows.

K₀: A time delay between a DCI slot and a physical downlink shared channel (PDSCH) slot.

K₁: A time delay between a PDSCH slot and a slot for transmitting feedback (e.g., ACK/NACK) information included in uplink control information (UCI).

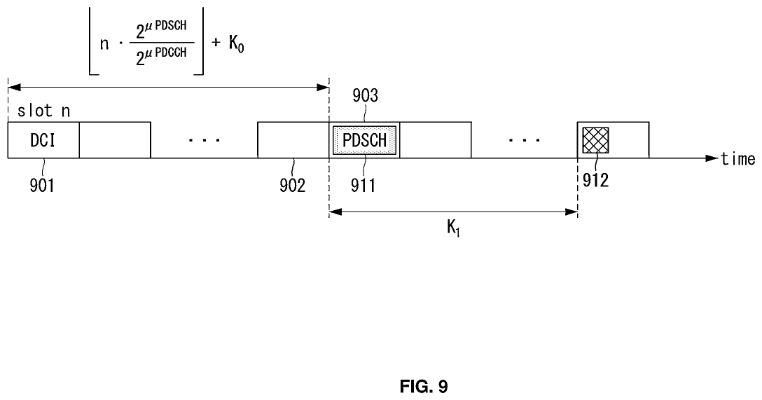

FIG. 9 is a conceptual diagram for describing a time at which a HARQ feedback is transmitted in NR.

As shown in FIG. 9, downlink control information (DCI) included in a physical downlink control channel (PDCCH) is transmitted in a slot n 901. Data indicated by the DCI, e.g., a PDSCH 903, may be transmitted in a slot 911 after a certain number of slots from the slot 901 in which the DCI is transmitted. Accordingly, there is a certain time delay from the slot n 901 to a slot 902 before the slot 911 in which the PDSCH 903 is transmitted, and this may be calculated as in Equation 1 below.

$$⌊ n \cdot \frac{{2}^{{μ}_{PDSCH}}}{{2}^{{μ}_{PDCCH}}} ⌋ + {K}_{0} \qquad [ Equation 1 ]$$

Equation 1 is described in the 3GPP NR technical specification TS 38.214. n indicates a slot including the scheduling DCI, μ_{PDSCH} indicates a subcarrier spacing (SCS) of the PDSCH, and 2^{μPDCCH} indicates a SCS of the PDCCH. As described above, K₀ may be a time delay between the DCI slot and the PDSCH slot, i.e., an offset value.

In addition, in FIG. 9, the PDSCH 903 may occupy the entire or part of one slot 911. Accordingly, within the slot 911 in which the PDSCH 903 is transmitted, L symbols starting from a specific symbol may be used for transmission of the PDSCH 903. Therefore, it should be noted that in FIG. 9, the PDSCH 903 and the slot 911 transmitting the PDSCH 903 are assigned different reference numerals.

A physical uplink control channel (PUCCH) may be transmitted in a slot 912 after slots corresponding to K₁ that is a certain offset from the slot 911 in which the PDSCH 903 is transmitted. The PUCCH may include uplink control information (UCI). HARQ feedback information for the PDSCH 903, e.g., ACK/NACK information, may be transmitted as being included within the UCI.

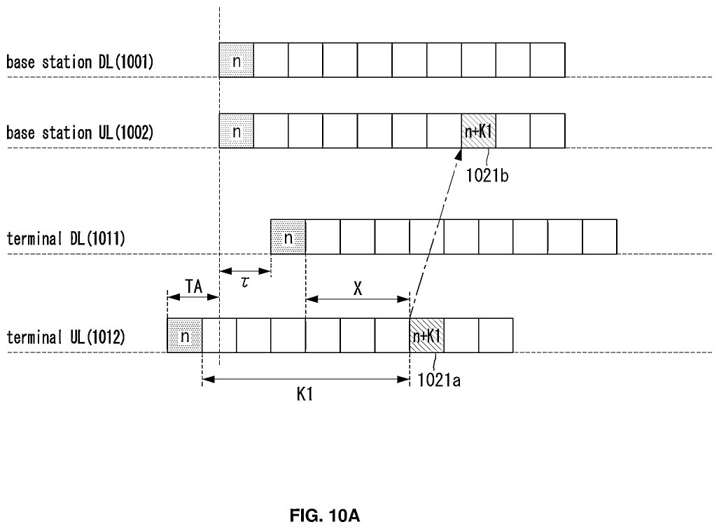

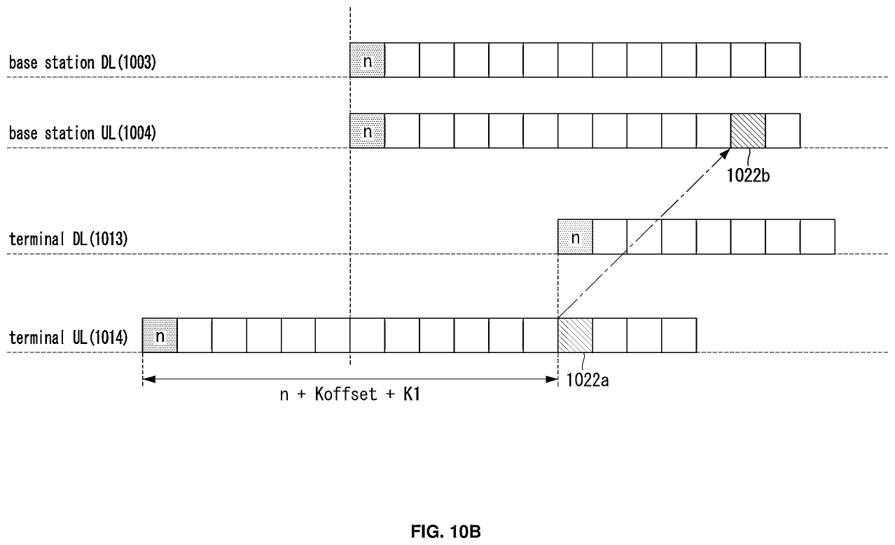

In addition, the base station or TRP and the terminal may be located at a distance from each other, and a delay corresponding to the distance may occur in signal transmission. This delay may be equally applied to the HARQ feedback described above. This is described in more detail below with reference to FIGS. 10A and 10B.

FIG. 10A is a conceptual diagram for describing a HARQ timing in TN. FIG. 10B is a conceptual diagram for describing a HARQ timing in NTN.

As shown in FIG. 10A, a downlink (DL) 1001 of a base station (gNB) and an uplink (UL) 1002 of the base station may be aligned in time as illustrated in FIG. 10A. In particular, the n-th slot of the DL and the n-th slot of the UL may be aligned to the same time.

The base station may transmit data (or packet or signal) to a terminal on a PDSCH using the DL 1001. Then, as illustrated in FIG. 10A, a time delay τ may occur based on a distance between the base station and the terminal. FIG. 10A illustrates the time delay between the DL 1001 of the base station and a DL 1011 of the terminal.

Uplink transmission needs to be performed by applying a timing advance (TA) value based on the distance between the terminal and the base station. Therefore, the terminal needs to perform transmission of data (or packet or signal) to the base station on the UL 1101 earlier by the TA so that the base station receives the signal at the same aligned time as the terminal 1002.

In FIG. 10A, K₁ is a time interval between the PDSCH slot and the slot transmitting UCI described in FIG. 9. In addition, since the terminal needs to actually transmit data (or HARQ feedback) in advance based on the TA value, a slot 1021a in which the terminal needs to transmit actual UCI may have a delay corresponding to X from the DL 1011 of the terminal as illustrated in FIG. 10A. Accordingly, the slot 1021b for the base station to receive the UCI through the UL 1002 may be determined based on the distance between the base station and the terminal.

FIG. 10A described above illustrates the HARQ timing in TN as an example. A case of NTN is described in more detail below with reference to FIG. 10B.

A base station in FIG. 10B may correspond to a satellite. When a satellite is used as a TRP, a connection between ‘satellite-gateway-base station’ may be established. Hereinafter, for convenience of description, a base station DL 1003 and a base station UL 1004 are described as illustrated in FIG. 10B, with reference numerals different from those of FIG. 10A.

The DL 1003 of the base station and the UL 1004 of the base station may be aligned in time as described in FIG. 10A. In particular, the n-th slot of the DL and the n-th slot of the UL may be aligned to the same time.

The base station may transmit data (or packet or signal) to the terminal on a PDSCH using the DL 1003. Then, a time delay may occur also in the case of FIG. 10B based on a distance between the base station and the terminal. When comparing FIG. 10B with FIG. 10A, it can be seen that a DL 1013 of the terminal has a significantly longer delay time compared to FIG. 10A. In addition, in order to align a UL 1014 of the terminal with the UL 1004 of the base station in time, the n-th slot in the UL 1014 of the terminal needs to be transmitted significantly more slots (longer time) before compared to FIG. 10A. This means that after data is received in the n-th slot through the DL 1003 of the base station, a slot 1022a for transmitting UCI including a feedback also needs to be transmitted quite early.

Therefore, in case of the terminal communicating with the satellite, it may be difficult to define the delay between the PDSCH slot and the slot transmitting UCI using only the factor of K₁ described above. Therefore, to compensate for this, K_{offset} may be additionally considered, and the HARQ timing is defined as in Equation 2 below.

$$n + {K}_{offset} + {K}_{1} \qquad [ Equation 2 ]$$

In Equation 2, n may indicate the n-th slot, K₁ may indicate a delay between the PDSCH slot and the slot transmitting UCI, and K_{offset} may be a value to compensate for the delay depending on the distance between the terminal and the satellite.

### [5G NR PUCCH and HARQ]

Hereafter, a PUCCH and HARQ according to the 5G NR technical specifications are described in more detail.

A PUCCH may be used to transmit UCI as previously described. UCI may include HARQ feedback, channel state information (CSI), scheduling request (SR), and/or the like. Components included in a PUCCH are described briefly as follows.

CSI or a CSI report may be similar to those used in LTE. However, they may differ from those of LTE in that they are slightly more complex. As in LTE, NR has several components of CSI. The components may include channel quality information (CQI), precoding matrix indicator (PMI), channel state information reference signal (CSI-RS) resource Indicator (CRI), synchronization signal/physical broadcast channel block (SS/PBCH block) resource indicator (SSBRI), layer indicator (LI), rank indicator (RI), and the like.

SR may be a physical layer message that requests an uplink grant (UL Grant) from the network so that the terminal can transmit a PUSCH.

Hereinafter, a HARQ feedback is described in more detail.

A HARQ feedback is allocated 1 bit per a transport block (TB). From the terminal's perspective, HARQ ACK/NACK feedbacks for reception of multiple PDSCHs may be transmitted on one PUSCH/PUCCH. A timing between a PDSCH reception and a corresponding ACK/NACK may be specified by DCI. A corresponding DCI field may be a PDSCH-to-HARQ_feedback timing indicator, and its value may be selected from a set configured by a dl-DataToUL-ACK information element (IE).

In addition, code block group (CBG)-based HARQ feedback is supported in the NR standard. In CBG-based HARQ feedback, 1 bit of feedback is supported for each CBG. One transport block (TB) may have multiple CBGs, and a codebook may be a bit sequence constructed using ACK/NACK feedbacks for multiple PDSCHs received during a time window indicated by DCI. This scheme may be used for carrier aggregation (CA), spatial multiplexing, and dual connectivity. The CBG-based HARQ feedback scheme supports two types of HARQ codebook. A Type 1 codebook supported by the CGB-based HARQ codebook scheme may be a fixed-size codebook according to a semi-static scheme. The Type 1 codebook is simple to use because it has a fixed size, but there are limitations due to the fixed size.

To resolve these limitations of the Type 1 codebook, a Type 2 codebook that transmits feedbacks only for actually transmitted CBG or TBs has been proposed. This scheme has an advantage of reducing feedback reporting overhead because the size varies depending on resource allocation.

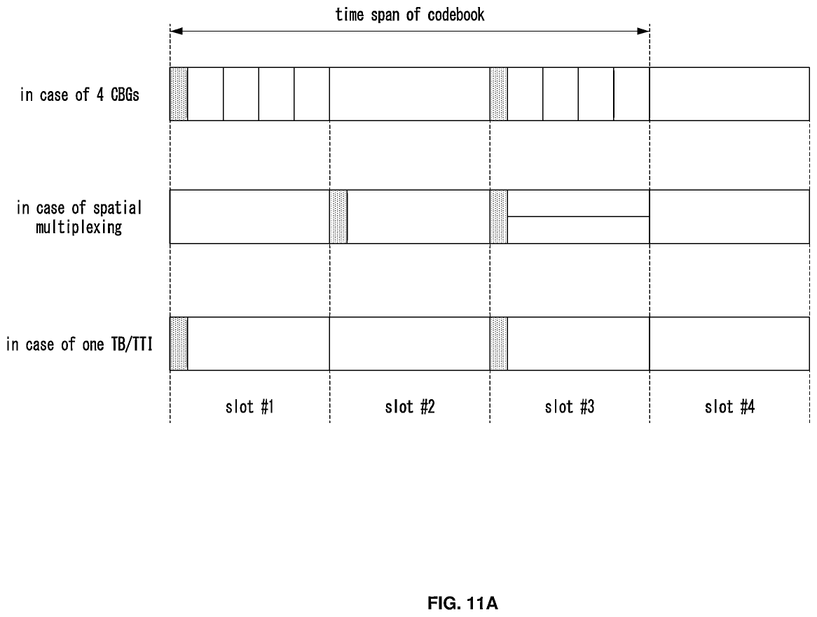

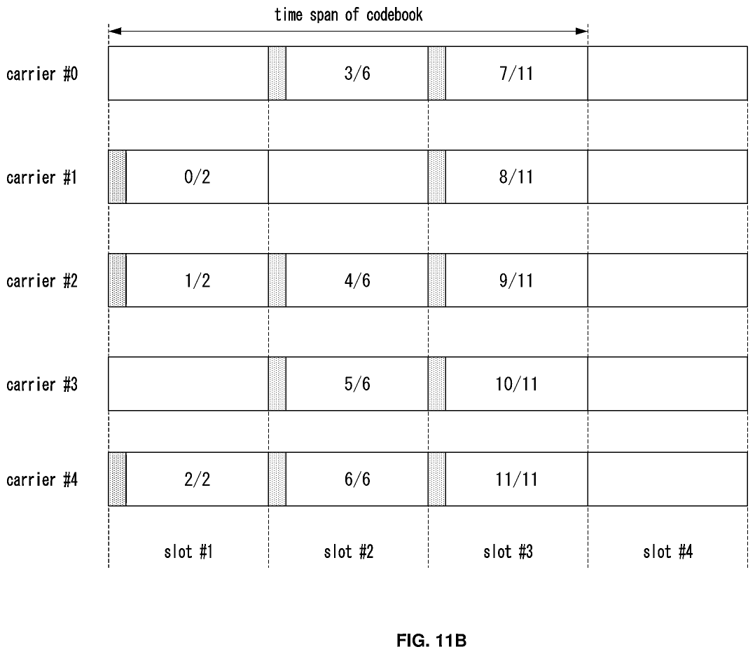

FIG. 11A is a conceptual diagram for describing a case of using a semi-static Type 1 HARQ codebook. FIG. 11B is a conceptual diagram for describing a case of using a dynamic Type 2 HARQ codebook.

As shown in FIG. 11A, a case where four CBGs are transmitted through one carrier, a case where spatial multiplexing is used in one carrier, and a case where one TB/TTI is transmitted are illustrated. In addition, for each case, four slots from a slot #1 to a slot #4 are illustrated, and a time span of each codebook is configured as three slots. Therefore, data is transmitted through three carriers, and the data may be transmitted in a different scheme for each carrier.

HARQ feedbacks required for the respective carriers illustrated in FIG. 11A are described in more detail below.

The case where four CBGs are transmitted through one carrier is described first. When four CBGs are transmitted through one carrier, transmission during the time span of codebook is described below using the example of FIG. 11A.

Since data (or packets, information, or signals) corresponding to four different CGBs are transmitted in the slot #1, information (ACKs/NACKs) for four HARQ feedbacks may be transmitted as corresponding to each data. This is described as follows.

When decoding of the first CGB transmitted in the slot #1 is successful, ACK may be transmitted as a HARQ feedback therefor. When decoding of the second CBG is successful, ACK may be transmitted as a HARQ feedback therefor. When decoding of the third CBG fails, NACK may be transmitted as a HARQ feedback therefor. When decoding of the last fourth CBG is successful, ACK may be transmitted as a HARQ feedback therefor. In addition, data may not be transmitted in the slot #2 during the time span of codebook. Therefore, feedback may not need to be transmitted in the slot #2. However, since a semi-static codebook is used and the first carrier comprises four CBGs, the same size of feedbacks need to be transmitted for each slot. Therefore, four pieces of feedback information may be transmitted in the slot #2 as well. However, since the terminal does not receive data in the slot #2, the terminal may transmit only NACKs as HARQ feedbacks. Accordingly, when the base station (or TRP) that has not transmitted data may interpret the feedbacks (i.e., feedbacks for the slot #2) as meaningless information. In addition, if the terminal transmits only NACKs like this, it may help the base station detect that data has not been received at the terminal in that slot. In the slot #3, the terminal may transmit feedback information in the same manner as the slot #1. Therefore, the HARQ feedbacks required in the first carrier requires a total of 12 bits of information.

Next, the case of the second carrier is described. HARQ feedbacks for the case where data is transmitted through two-layer spatial multiplexing may be transmitted through the second carrier. According to the example of FIG. 11A, since the terminal does not receive data in the slot #1, only NACKs may be transmitted as HARQ feedbacks. In other words, as described above, although the terminal may not need to feed back any information because data is not transmitted, since a semi-static codebook is used, the terminal may need to feedback only NACKs indicating that data is not received or that decoding fails. Since it is assumed that the second carrier allows two-layer spatial multiplexing, 2 bits of NACKs may be transmitted. In addition, data to which spatial multiplexing is not applied may be transmitted in the slot #2. Therefore, for the slot #2, one bit may be allocated as a feedback indicating ACK/NACK for one transmission, and the other bit may be allocated as a NACK feedback for another data transmissions that is not spatially multiplexed, thereby allowing 2 bits to be transmitted. For the slot #3, since two different types of data (or packets, signals, or information) are transmitted through spatial multiplexing, 2 bits are required to indicate ACK/NACKs of the respective data transmitted through spatial multiplexing. Accordingly, a total of 6 bits of HARQ feedbacks may be transmitted for the second carrier.

Lastly, the case of the third carrier is described. In the third carrier, transmission may be performed in units of one TB or one TTI. When transmission is performed in units of one TB or one TTI as described above, a HARQ feedback with one bit may be transmitted in each slot (e.g., slot #1, slot #2, or slot #3). Since data is transmitted in the slot #1, one bit feedback indicating ACK/NACK may be transmitted, and since there is no data transmitted in the slot #2, one bit feedback indicating NACK may be transmitted. Since data is transmitted in the slot #3, one bit feedback indicating ACK/NACK may be transmitted.

When data is transmitted by applying different schemes to three carriers as described with reference to FIG. 11A, the HARQ feedbacks may require a total of 21 bits of information.

FIG. 11B assumes a case where a time span of codebook is three slots through five carriers (i.e., carrier #0, carrier #1, carrier #2, carrier #3, carrier #4). When using a dynamic HARQ codebook, a downlink assignment index (DAI) used in the LTE standard may be used. In the NR standard, the DAI may be classified into two types. The DAI may be classified into a count DAI (cDAI) and a total DAI (tDAI) which count the number of TBs. tDAI may represent the total number of data transmitted in a specific slot based on the number of carriers, and cDAI may be a carrier order-based indicator indicating whether data is transmitted in the specific slot. tDAI and cDAI are described in more detail below with reference to FIG. 11B.

In FIG. 11B, a time span of codebook is assumed to be three slots as described in FIG. 11A.

In case of the carrier #0, no data is transmitted in the slot #1, data is transmitted in the slot #2, and data is transmitted in the slot #3. In case of the carrier #1, data is transmitted in the slot #1, no data is transmitted in slot #2, and data is transmitted in the slot #3. In case of the carrier 3, data is transmitted in the slots #1 to #3. In case of the carrier #3, no data is transmitted in the slot #1 and data is transmitted in the slots #2 and #3. In case of the carrier #4, data is transmitted in the slots #1 to #3.

In the above-described case, the total number of data transmissions in the first slot, i.e., tDAI, may be 3, and the data may be transmitted in the carrier #1, carrier #2, and carrier #4. Therefore, a form of (cDAI/tDAI) is illustrated in FIG. 11B, and cDAIs may be allocated to carriers in the order as illustrated in FIG. 11B. (cDAI/tDAI) in the slot #1 of the carrier #1 may be (0/2), (cDAI/tDAI) in the slot #1 of the carrier #2 may be (1/2), and (cDAI/tDAI) in the slot #1 of the carrier #4 may be (2/2). Accordingly, whether data reception in the first slot on a specific carrier fails may be identified based on cDAI/tDAI.

The same scheme may be applied to the slot #2 and slot #3. In the scheme of FIG. 11B described above, the HARQ report may consist of 12 bits, one for each transport block received during the time span of codebook.

The above-described schemes need to be applied to HARQ feedbacks in the multi-TRP NTN environment. However, as described with reference to FIG. 8, since satellites in different orbits may each operate as TRPs in the multi-TRP NTN environment, there may be a problem in that they have different delay times.

Even with these different time delays, the delay times may be basically much longer than when implemented as a TN system. Therefore, when transmitting HARQ feedbacks in the multi-TRP NTN environment, a method is needed to achieve a low latency by transmitting a control signal through a link with a relatively short delay. In addition, a method is needed to alleviate a HARQ stalling problem in the multi-TRP NTN environment. In particular, when a difference between delays of two links is quite large, a HARQ feedback scheme suitable for a case not requiring strict synchronization such as carrier aggregation may be needed.

Therefore, the present disclosure described below proposes various specific implementation methods for transmitting HARQ feedback control signals through a link with a smaller delay, and methods for transmitting retransmission data itself through a link with a smaller delay.

Hereinafter, several example embodiments of the present disclosure are described in more detail. Each described embodiment may be performed independently, or two or more described embodiments may be used in combination. Examples of combinations of the described embodiments are provided below. However, additional combinations that can be inferred by a person having ordinary skill in the art from the following description should be understood to be included in the scope of the present disclosure.

### First Embodiment: HARQ Feedback Transmission Using a Link with a Small Latency

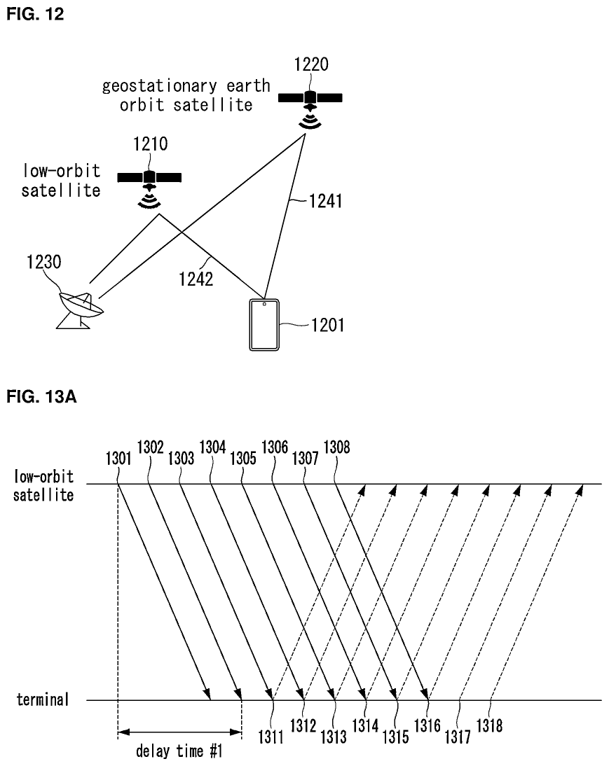

FIG. 12 is a conceptual diagram for describing links for communicating with satellites in different orbits according to an embodiment of the present disclosure.

As shown FIG. 12, a terminal 1201, a low-orbit satellite 1210, a GEO satellite 1220, and a gateway 1230 are illustrated. It should be noted that a connection between the base station and the gateway 1230 is omitted in FIG. 12. The two different satellites in FIG. 12 may be satellites in different orbits. For example, the GEO satellite may be an example of a high-orbit satellite, and the low-orbit satellite 1210 may be, for example, a LEO satellite. Alternatively, the low-orbit satellite 1210 may be a satellite with a relatively lower orbit than the GEO satellite 1220 and may be a medium-orbit (MEO) satellite.

As described above, the two different satellites may be satellites in different orbits, or may be satellites in the same orbit but respectively having a short link and a long link due to different distances from the terminal. However, in the following description, for convenience of description, the satellites are described as a low-orbit satellite and a GEO satellite as an example. Further, it is assumed that the satellites described in the present disclosure are transparent payload-based NTN satellites or bent-pipe satellites that do not process data as described above.

The low-orbit satellite 1210 and the GEO satellite 1220 may operate as different TRPs according to embodiments of the present disclosure. The low-orbit satellite 1210 and the GEO satellite 1220 may belong to a multi-TRP having wireless channels that transmit data to one terminal 1201. Specifically, the terminal 1201 may use a first path 1241 to the gateway 1230 through the GEO satellite 1220, and the terminal 1201 may use a second path 1242 to the gateway 1230 through the low-orbit satellite 1210 simultaneously with the first path or separately from the first path.

FIG. 12 illustrates uplink paths, but the following description may be equally applied to downlink paths. Specifically, the gateway 1230 may use the first path 1241 to the terminal 1201 through the GEO satellite 1220, and the gateway 1230 may use the second path 1242 to the terminal 1201 through the low-orbit satellite 1210 simultaneously with the first path or separately from the first path. When the first path 1241 is classified into a downlink path and an uplink path as necessary, the first path 1241 may be classified into a first downlink path and a first uplink path. When the second path 1242 is classified into a downlink path and an uplink path as necessary, the second path 1242 may be classified into a second downlink path and a second uplink path.

In addition, each of the paths described above (i.e., the first path 1241 and the second path 1242) may be understood as being replaced with a link. In other words, the first path 1241 and the second path 1242 may be understood identically even when they are described as a first link 1241 and a second link 1242, respectively.

Referring still to FIG. 12, the first path 1241 and the second path 1242 may have different delays based on altitudes of the satellites. Specifically, the first path 1241 using the GEO satellite 1220 may be a link (or path) with a relatively longer delay time than the second path using the low-orbit satellite 1210.

Therefore, as described above, a case where not only data but also information (or packet, data, or signal) fed back by the terminal 1201 in response to data transmission is transmitted using the first path 1241 may have a relatively longer delay time than a case of using the second path 1242 to transmit the information. For example, when the terminal 1201 transmits a HARQ feedback for received data, a delay time when the HARQ feedback is transmitted through the first path 1241 is t1, and a delay time when the HARQ feedback is transmitted through the second path 1242 is t2, and it can be seen that t1 is longer than t2.

Therefore, embodiments of the present disclosure provide a method for transmitting HARQ feedbacks using a satellite with a smaller delay when the terminal establishing links with two or more different satellites operating as a multi-TRP transmits the HARQ feedbacks. According to embodiments of the present disclosure, a latency can be reduced and a HARQ stalling phenomenon can be alleviated. According to embodiment of the present disclosure, a terminal establishing links with two or more different satellites operating as a multi-TRP may transmit feedback information for different links through a link of a satellite with a smaller delay among the two or more links.

The following case may be considered in the scenario illustrated in FIG. 12. Multi-TRP transmission may be performed to at least one terminal 1201 through connections with two satellites 1210 and 1220 having different path delays. In various multi-TRP situations, the logically separated gateway 1230 and base station (e.g., gNB, not shown in FIG. 12) may be physically co-located or connected by an ideal backhaul even when they are physically separated. In addition, the one gateway 1230 may be connected to multiple satellites, and one base station may be connected to multiple gateways through ideal backhaul links.

FIG. 12 may correspond to a specific example of the above-described scenarios. The one gateway 1230 connected to the base station (not shown in FIG. 12) through an ideal backhaul link may be connected to a plurality of satellites 1210 and 1220, and multi-TRP transmission may be performed to one terminal 1201 through two satellites 1210 and 1220.

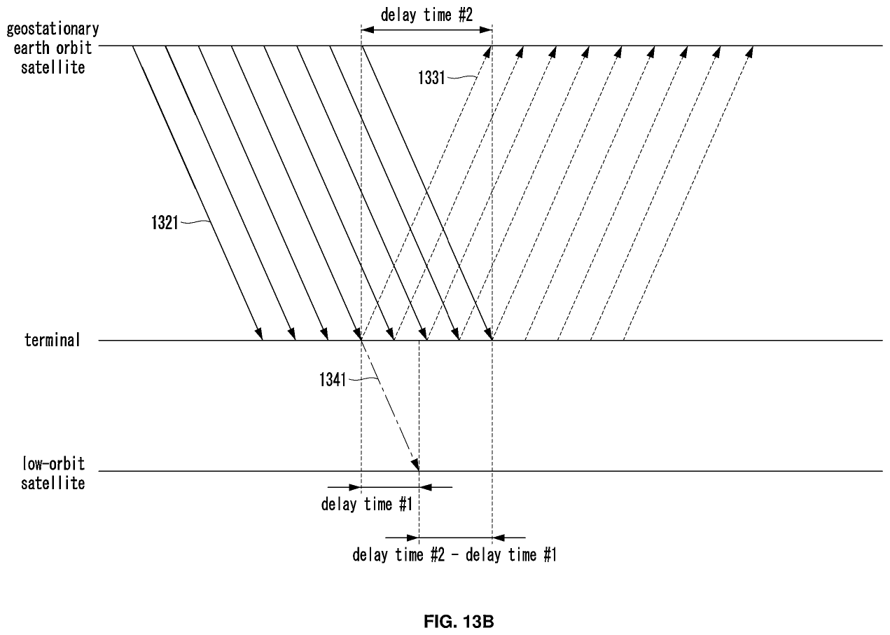

FIG. 13A is a timing diagram for describing a time delay of a signal received from one satellite and transmission of a feedback signal corresponding thereto.

As shown in FIG. 13A, it is assumed that a low-orbit satellite transmits data (or packet or signal) to a terminal through a downlink channel. Generally, when transmitting a downlink channel, data may be transmitted on a slot basis. Therefore, in FIG. 13A, each of a plurality of arrows directing from the low-orbit satellite to the terminal may mean data 1301 to 1308 transmitted from the low-orbit satellite through the downlink channel. In addition, the data 1301 to 1308 may refer to respective slots through which the corresponding data is transmitted. In addition, the downlink channel illustrated with a diagonal line in FIG. 13A is to describe a delay time. In other words, an absolute time at which the low-orbit satellite transmits a signal and an absolute time at which the terminal receives the signal are different times, and a time delay equal to ‘delay time #1’ may occur.

When the terminal receives data from the low-orbit satellite, the terminal may process the received data and transmit a feedback signal to the low-orbit satellite after a certain time period. In FIG. 13A, it is assumed that each of the feedbacks 1311 to 1318 is transmitted to the low-orbit satellite at a time delayed by 2 slots.

FIG. 13B is a conceptual diagram for describing delay times and feedbacks when receiving data from satellites located at different altitudes.

In FIG. 13B, in order to represent different distances to the satellites, transmission and reception of signals with a GEO satellite located in a high orbit is illustrated above a terminal, and transmission and reception of signals with a low-orbit satellite is illustrate below the terminal. It should be noted that in FIG. 13B, a low-orbit satellite with a short distance from the terminal is illustrated below the terminal in order to intuitively represent that the distance from the terminal to the GEO satellite is a longer distance than the distance from the terminal to the low-orbit satellite.

The GEO satellite may transmit data to the terminal through a downlink channel 1321 (e.g., PDSCH) as described in FIG. 13A. For example, it is assumed that a HARQ-ACK/NACK, which corresponds to the first data, is transmitted after 3 slots, unlike in FIG. 13A. Typically, a HARQ feedback corresponding to data received from the GEO satellite is transmitted to the GEO satellite. Accordingly, the feedback signal may be transmitted as indicated by a reference numeral 1331. In this case, a delay time of the feedback signal transmitted from the terminal to the GEO satellite is illustrated as ‘delay time #2’ in FIG. 13B.

On the other hand, a time required for the terminal to transmit a signal to the low-orbit satellite may have a value of the delay time #1, as previously described in FIG. 13A. As illustrated in FIG. 13B, when comparing the delay time #1 required for the terminal to transmit a signal to the low-orbit satellite with the delay time #2 required for the terminal to transmit a signal to the GEO satellite, the delay time #1 is a shorter delay time. In FIG. 13B, a time corresponding to a difference between the delay time #2 and delay time #1 is also illustrated.

In embodiments of the present disclosure, the feedback signal (i.e., HARQ feedback signal) may be transmitted to the low-orbit satellite rather than the GEO satellite. Therefore, when transmitting the HARQ feedback corresponding to the PDSCH received from the GEO satellite to the low-orbit satellite according to an embodiment of the present disclosure, the time delay may be reduced by (delay time #2-delay time #1) as illustrated in FIG. 13B.

The HARQ feedback may be transmitted through a PUCCH as described previously. Embodiments of the present disclosure provide two methods of transmitting the PUCCH.

### First Method for PUCCH Operation

The first method of PUCCH operation according to an embodiment of the present disclosure may be a method of expanding and using field(s) of the PUCCH on the link with a smaller delay. In other words, the first method of PUCCH operation according to an embodiment of the present disclosure may be to transmit HARQ feedback information for multiple links on one PUCCH. For example, an additional field may be configured in the PUCCH for the low-orbit satellite with a smaller delay, or a HARQ codebook may be utilized in the PUCCH for the low-orbit satellite.

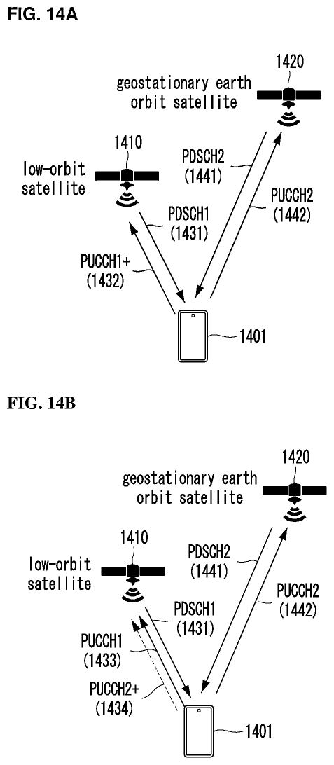

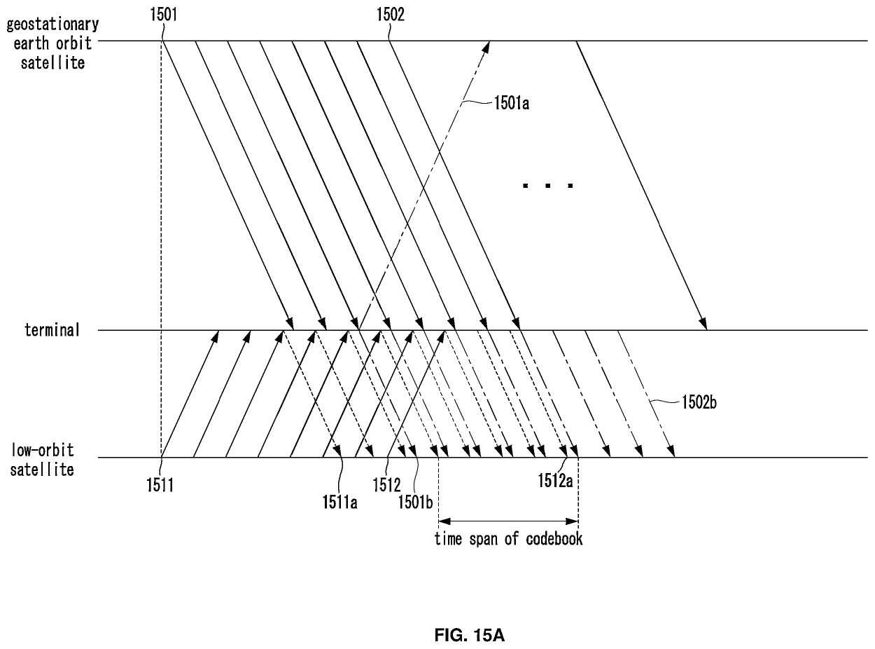

FIG. 14A is a conceptual diagram for describing a first method of PUCCH operation according to an embodiment of the present disclosure in an environment where multiple satellites are used as TRPs.

As shown in FIG. 14A, only a terminal 1401, low-orbit satellite 1410, and GEO satellite 1420 are illustrated. In other words, FIG. 14A is a diagram in which a gateway, base station, and core network are omitted. The terminal 1401 may transmit and receive data (or packet, information, or signal) with the low-orbit satellite 1410 through a PDSCH1 1431 and a PUCCH1+1432 according to an embodiment of the present disclosure. In addition, the terminal 1401 may transmit and receive data with the GEO satellite 1420 through a PDSCH2 1441 and a PUCCH2 1442.

The two different satellites illustrated in FIGS. 14A and 14B may be satellites in different orbits, as described above, or may be satellites respectively having a short link and a long link due to different distances from the terminal even when they are satellites in the same orbit. However, in the following description, for convenience of description, the satellites are described as a low-orbit satellite and a GEO satellite as an example. Further, it is assumed that the satellites described in the present disclosure are transparent payload-based NTN satellites or bent-pipe satellites that do not process data as described above.

As illustrated in FIG. 14A, the PUCCH between the terminal and the low-orbit satellite 1410 may use an extended field. Therefore, in FIG. 14A, it is indicated that the PUCCH between the terminal and the low-orbit satellite 1410 has the extended field by expressing it as ‘PUCCH1+1432’. The extended field may be a field including HARQ feedback information for data received from the GEO satellite 1420 through the PDSCH2 1441. In this case, according to an embodiment of the present disclosure, the extended field may be configured to include HARQ feedback information for all data received through the PDSCH2 1441.

In order to use the extended field according to an embodiment of the present disclosure, the base station may acquire UE capability information of the terminal 1401 in advance, and determine whether the terminal 1401 is capable of using the extended field based on the UE capability information. When the terminal 1401 is capable of using the extended field, the base station may indicate the terminal to use the extended field by using higher layer signaling and/or resource allocation information. When using the extended field according to the first embodiment of the present disclosure, the terminal 1401 may transmit only HARQ feedback information through the extended field. Therefore, since the PUCCH1+1432 according to an embodiment of the present disclosure transmits only HARQ feedback information corresponding to the PDSCH(s) received from the GEO satellite 1420, the PUCCH2 1442 between the GEO satellite 1420 and the terminal 1401 may be transmitted in a form excluding the HARQ feedback information or in a form including the HARQ feedback information.

In addition, in order to avoid impacts on the specifications, the extended field according to an embodiment of the present disclosure may be transmitted by being included in some of fields of a PUSCH1 (not shown in FIG. 14A) configured with the low-orbit satellite 1410. In this case, the PUCCH1+1432 may include at least one bit to indicate that HARQ feedback information corresponding to the data received through the PDSCH2 1441 is transmitted through the PUSCH1. When a higher layer signaling is used for the base station to indicate the terminal 1401 to transmit HARQ feedback information corresponding to data received through the PDSCH2 1441 through the PUSCH1, no additional bits may be allocated to the PUCCH1+1432. When such the higher layer signaling is not used, the base station may provide such configuration information to the terminal when allocating resources. As another example, the base station may indicate, through a higher layer signaling, the terminal to use a form of PUCCH1+ from a specific time point or when a specific satellite is added, and the base station may indicate whether to add a new satellite when allocating resources.

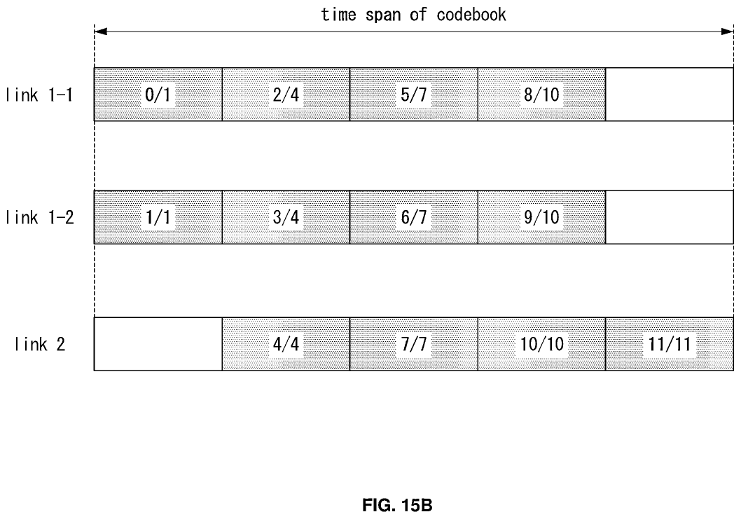

The operations method described above are described in more detail below with reference to FIG. 15A.

FIG. 15A is a conceptual timing diagram for describing a method of transmitting HARQ feedback information according to an embodiment of the present disclosure.

In FIG. 15A, two different satellites may be satellites in different orbits, as described above, or may be satellites in the same orbit but respectively having a short link and a long link due to different distances from the terminal. However, in the following description, for convenience of description, the satellites are described as a low-orbit satellite and a GEO satellite as an example. In addition, it is assumed that the satellites described in the present disclosure are transparent payload-based NTN satellites or bent-pipe satellites that do not process data as described above.

As shown in FIG. 15A, a timing of a signal transmitted and received with the GEO satellite is illustrated above the terminal, and a timing of a signal transmitted and received with the low-orbit satellite is illustrated below the terminal, in the same form as previously described in FIG. 13B.

Assuming that both the GEO satellite and low-orbit satellite transmit signals at the same time, the GEO satellite may transmit its first data (or packet, information, or signal) 1501 through a PDSCH, and the low-orbit satellite may transmit its first data (or packet, information, or signal) 1511 through a PDSCH. Since a distance from the GEO satellite is greater than a distance from the low-orbit satellite, the data transmitted through the PDSCH from the GEO satellite may be received later than the data transmitted through the PDSCH from the low-orbit satellite.

FIG. 15A shows a case where the GEO satellite transmits data to the terminal eight times through PDSCHs, and the low-orbit satellite transmits data to the terminal eight times through PDSCHs.

When receiving data through a PDSCH from the low-orbit satellite, the terminal may transmit a HARQ feedback to the low-orbit satellite. Accordingly, the terminal may receive the first data 1511 transmitted by the low-orbit satellite through the PDSCH and transmit a HARQ feedback corresponding to the first data 1511 to the low-orbit satellite through a first PUCCH 1511a.

In addition, when receiving data through a PDSCH from the GEO satellite, the terminal may transmit a HARQ feedback to the GEO satellite, or may transmit the HARQ feedback to the low-orbit satellite as described in the present disclosure. In FIG. 15A, a reference numeral 1501a indicates a case in which the terminal transmits the HARQ feedback to the GEO satellite, and a reference numeral 1501b indicates a case in which the terminal transmits the HARQ feedback to the low-orbit satellite rather than the GEO satellite.

In FIG. 15A, a HARQ timing for the case where the terminal transmits the HARQ feedback to the GEO satellite and a HARQ timing for the case where the terminal transmits the HARQ feedback to the low-orbit satellite as described in the present disclosure may be indicated by the reference numerals 1501a and 1501b.

In the environment where two or more satellites operate as multiple TRPs, it can be seen that the HARQ feedback transmission timings vary even when both the GEO satellite and the low-orbit satellite transmit signals at the same time. Accordingly, when transmitting the HARQ feedback in a first time period, the terminal may transmit only the HARQ feedback for the data received through the PDSCH of the low-orbit satellite. Then, after a certain time period from a reception time of the PDSCH from the GEO satellite, the terminal may transmit the HARQ feedback corresponding to the PDSCH received from the GEO satellite to the low-orbit satellite. The HARQ feedbacks may be transmitted based on the first method or the second method described with reference to the first embodiment of the present disclosure.

In addition, when applying the first method according to an embodiment of the present disclosure with reference to the case of FIG. 15A, the data may be transmitted to the terminal 1401 through links formed with satellites operating as TRPs, e.g., PDSCHs, as described above. In this case, assuming that a dynamic feedback is transmitted using a Type 2 codebook with a 5 slot time span for HARQ feedbacks, the first link (i.e., PDSCH1 1431) configured between the low-orbit satellite 1410 and the terminal 1401 may have two CBGs, and the second link (i.e., PDSCH2 1442) configured between the GEO satellite 1420 and the terminal 1401 may have one CBG.

In this case, when there is no transmission on the second link (i.e., PDSCH2 (1442)) in the first slot, and there is no transmission on the first link (i.e., PDSCH1 1431)) in the last slot cDAI/tDAI may be implemented as illustrated in FIG. 15B.

FIG. 15B is a diagram for describing cDAI/tDAI when the first link has two CBGs and the second link has one CBG.

The cDAI/tDAI illustrated in FIG. 15B may be used to identify a success or failure of data transmission of each slot as previously described in FIG. 11B. As illustrated in FIG. 15B, the terminal 1401 may identify a CBG or TB in which an error occurs by using the cDAI/tDAI.

### Second Method for PUCCH Operation

The first method of operating the PUCCH according to an embodiment of the present disclosure may be a method of transmit control information of a link with a longer delay by adding a new PUCCH on a link with a smaller delay in order to transmit control information of the link with a longer delay.

FIG. 14B is a conceptual diagram for describing a second method of PUCCH operation according to an embodiment of the present disclosure in an environment where multiple satellites are used as TRPs.

As shown in FIG. 14B, only the terminal 1401, low-orbit satellite 1410, and GEO satellite 1420 are illustrated. In other words, FIG. 14B is also a diagram in which a gateway, base station, and core network are omitted. The terminal 1401 may transmit and receive data (or packet, information, or signal) with the low-orbit satellite 1410 through the PDSCH1 1431, PUCCH1 1432, and PUCCH2+1434 according to an embodiment of to the present disclosure. In addition, the terminal 1401 may transmit and receive data with the GEO satellite 1420 through the PDSCH2 1441 and the PUCCH2 1442.

The PUCCH2+1434 according to an embodiment of the present disclosure may be a newly defined control channel for transmitting only HARQ feedback information corresponding to a PDSCH received from the GEO satellite 1420. In addition, since the PUCCH2+1434 transmits only HARQ feedback information corresponding to the PDSCH(s) received from the low-orbit satellite 1420, the PUCCH2 1442 between the GEO satellite 1420 and the terminal 1401 may be transmitted in a form excluding the HARQ feedback information or in a form including the HARQ feedback information.

In order to avoid impacts on the specifications, the PUCCH2+1434 according to embodiments of the present disclosure described above may be transmitted by being included in some of fields of a PUSCH1 (not shown in FIG. 14A) configured with the low-orbit satellite 1410. In this case, in order to notify that the PUCCH2+1434 is additionally transmitted, an indicator to indicate this may be additionally configured in the PUCCH1 1433. For example, it may further include an indicator indicating that a control channel for transmitting feedback information of the second satellite data is also transmitted.

As another example, when the base station pre-configures the terminal 1401 to additionally transmit the PUCCH2+1434, the additional indicator may not be configured in the PUCCH1 1433. This pre-configuration by the base station may be made using higher layer signaling or when allocating resources.

In this case, operations in the multi-TRP NTN environment are as follows.

First, the low-orbit satellite 1410 and the GEO satellite 1420 may operate as TRPs for the terminal. In a typical TN, when communicating with different TRPs, a difference in timings of HARQ feedbacks received through two links may not be large. However, since the difference in transmission delays of links is large in the NTN environment, additional considerations different from the TN environment are required.

Second, in an initial configuration stage, the delay time #1 that is the link delay t1 between the low-orbit satellite 1410 and the terminal 1401 may be compared with the delay time #2 that is the link delay t2 between the GEO satellite 1420 and the terminal 1401, and a link with a smaller delay may be determined to be a short link.

Third, in case of the low-orbit satellite 1410, the time delay #1 may vary as the low-orbit satellite 1410 moves. Further, there may be a case where both satellites are not GEO satellites. For example, different satellites operating as TRPs may all be LEO satellites, or one of the satellites operating as TRPs may be a LEO satellite and the other may be a MEO satellite. In this case, since the two satellites move, the time delay #1 and time delay #2 may vary continuously. Therefore, when two satellites are constantly move or at least one satellite moves, a short link may need to be changed. For a specific example of this case, it may be assumed that a link between a satellite1 and a terminal is a short link, a time delay #1 between the satellite1 and the terminal is t1, and a time delay #2 of a current link between the satellite2 and the terminal is t2. Since the link between the satellite1 and the terminal is a short link, a relationship t1<t2 may be established. However, as both or at least one satellite moves, t1 may change, or both t1 and t2 may change. In this case, the effects of the present disclosure may be achieved only when changing the short link. Therefore, if the t1 and t2 values change, the short link may be changed using one of methods below.

First embodiment of short link change: A direction in which the satellite1 moves may be a specific direction. Therefore, a case where t1 increases may correspond to a case where the satellite1 moves away from the terminal 1401. In other words, it may be difficult that a case where the satellite1 gets closer to the terminal 1401 occurs again after moving away from the terminal 1401. Accordingly, the short link may be changed when t2 becomes smaller than t1.

Second embodiment of short link change: A link between a satellite and the terminal is largely based on a line of sight (LOS) distance. However, radio waves may be scattered by other flying objects, such as airplanes or drones. In this case, the link between the satellite and the terminal may have a distance value different from the LOS distance. As another example, when a user moves while carrying the terminal, radio waves may be scattered due to terrain characteristics or obstacles such as buildings. In this case, the link between the satellite and the terminal may have a distance value different from the LOS distance. A distance between a specific satellite and a terminal may be measured as a longer distance than an actual distance therebetween instantaneously due to the factors (e.g., movement) described above or other factors. Even when the distance between the terminal and the satellite1 is actually shorter than the distance between the terminal and the satellite2, if a case where t1 becomes longer than t2 occurs due to a certain reason, short link changes may occur continuously. In other words, a ping-pong phenomenon of short link changes may occur.

Therefore, an embodiment of the present disclosure may additionally use a preset margin value t. For example, even when t2 becomes smaller than t1, the short link may be changed only if t2 becomes sufficiently smaller than t1 by the preset margin value. In other words, the short link may be changed if (t2<t1-τ) is satisfied. The margin value may be preconfigured, may be a value predefined in the technical specification, or may be given through higher layer signaling.

Fourth, determination of whether to change the short link according to an embodiment of the present disclosure may be performed periodically or at a predetermined time based on constellation of the satellites.

Fifth, assuming that K_{offset} described in FIG. 10B is given simply as a round trip delay (RTD) time, simply for the satellite1 may be a value obtained by adding K₁ to a doubled value of t1, and K_{offset} for the satellite2 may be a value obtained by adding K₁ to a doubled value of t2. In this case, if a HARQ feedback for a PDSCH received from the satellite2, which has a long link, is transmitted through a short link, a HARQ feedback timing may be (t1+t2+K₁). Accordingly, when transmitting, through the short link, the HARQ feedback for the data transmitted through the long link, information on the modified HARQ timing may be indicated through a higher layer message (e.g., RRC message) or calculated using HARQ timing values of the respective links.

Sixth, in case of using the second method of PUCCH operation, since a HARQ feedback is transmitted independently for data transmission of each link, the HARQ timing needs to be appropriately modified. For example, the HARQ feedback for the satellite1 may be used as is because it is a HARQ feedback corresponding to a PDSCH of a short link. However, a feedback timing for the satellite2 may be appropriately modified based on the method described in the fifth point.

Seventh, in case of using the first method of PUCCH operation, HARQ feedbacks for data transmissions of the links of the satellite1 and satellite2 (i.e., PDSCH1 from the satellite1 and PDSCH2 from the satellite2) may be transmitted jointly. Therefore, in case of the first method of PUCCH operation, HARQ process identifiers (process IDs) of the respective links within a time span of codebook may be indicated in addition to HARQ timing information. For example, a HARQ process identifier corresponding to the PDSCH1 from the satellite1 and a HARQ process identifier corresponding to the PDSCH2 from the satellite2 may be indicated, respectively.

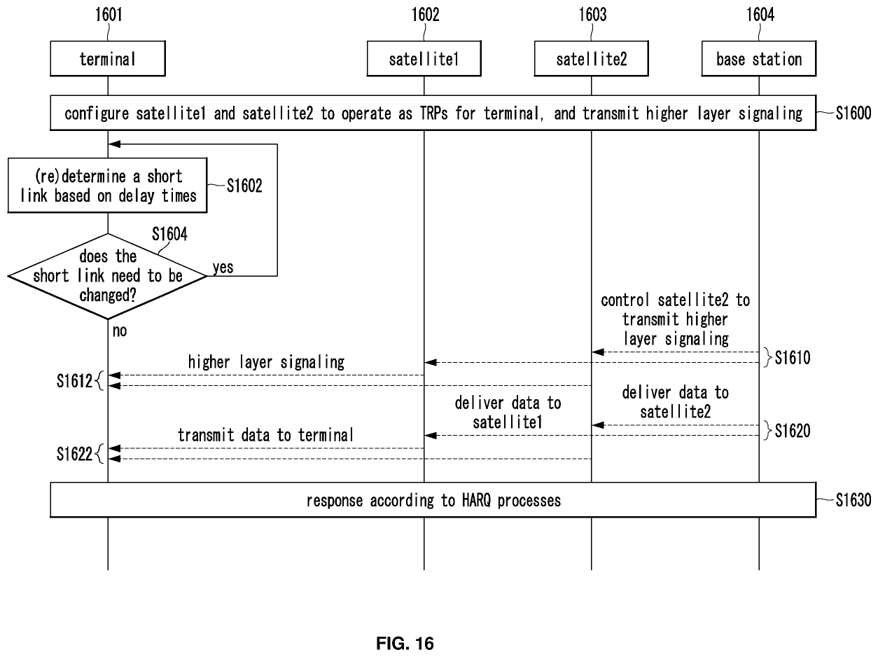

FIG. 16 is a signal flow diagram for describing a HARQ feedback operation in an environment in which two satellites operate as TRPs, according to an embodiment of the present disclosure.

The two satellites may be satellites in different orbits, as described above, or may be satellites in the same orbit but respectively having a short link and a long link due to different distances from the terminal. In addition, it is assumed that the satellites described in the present disclosure are transparent payload-based NTN satellites or bent-pipe satellites that do not process data as described above.

In FIG. 16, a terminal 1601, satellite1 1602, satellite2 1603, and base station 1604 are illustrated. In FIG. 16, a gateway may be located between the satellites 1602 and 1603 and the base station 1604, or the base station may be directly connected to the satellites 1602 and 1603. In case of a system environment having a gateway, it can be understood that the gateway is omitted in FIG. 16. In addition, one of the satellite1 1602 and the satellite2 1603 may be a GEO satellite, and the other satellite may be a LEO satellite. As another example, one of the satellite1 1602 and the satellite2 1603 may be a MEO satellite, and the other satellite may be a LEO satellite. As another example, both the satellite1 1602 and the satellite2 1603 may be LEO satellites. The satellites may also be other types of satellites. The embodiment of present disclosure illustrated in FIG. 16 may be applied when a distance between the terminal 1601 and the satellite1 1602 and a distance between the terminal 1601 and the satellite2 1603 are different.

In a step or operation S1600, the base station 1604 may configure the satellite1 1602 and the satellite2 1603 to operate as TRPs for the terminal 1601. Additionally, the base station 1604 may transmit higher layer signaling so that the terminal 1601 establishes links with the satellite1 1602 and the satellite2 1603, respectively. Through this operation, a first link may be established between the terminal 1601 and the satellite1 1602, and a second link may be established between the terminal 1601 and the satellite2 1603.

In a step or operation S1602, the terminal 1601 may determine or redetermine a short link based on time delays of the links configured with the satellites. As described above, RTD values between the terminal 1601 and the satellites may be measured, and the terminal 1601 may determine a short link based on the measured RTD values.

In a step or operation S1604, the terminal 1601 may check whether the short link needs to be changed. As described above, the change of the short link may be periodically determined based on the delay times of the respective satellites or based on the delay times of the respective satellites and the margin value t.

If the short link needs to be changed as a result of the checking in step S1604, the terminal 1601 may proceed to the step or operation S1602 to redetermine the short link.

In a step or operation S1610, the base station 1604 may control the satellite1 1602 and the satellite2 1603 to transmit higher layer signaling so that the terminal configures the previously described PUCCH allocation method and/or operation method. Dotted lined in FIG. 16 indicate that when notified in advance through higher layer signaling before a time in FIG. 16, steps or operations indicated by the dotted lines may not be done at the time described in FIG. 16. In the following description, it is assumed that the satellite1 1602 and the satellite2 1603 are controlled by the base station 1604 to transmit the higher layer signaling in the step or operation S1610.

In a step or operation S1612, the satellite1 1602 and the satellite2 1603 may each transmit higher layer signaling to the terminal 1601. In an embodiment, the satellite1 1602 and the satellite2 1603 may transmit information indicated by the base station 1604 to transmit to the terminal 1601. As described above, the higher layer signaling may include information indicating the allocation method and/or method of PUCCH operation according to an embodiment of the present disclosure.

In a step or operation S1620, the base station 1604 may transmit, to the satellite1 1602 and satellite2 1603, data to be transmitted to the terminal 1601 by dividing the data into a part for the satellite1 and a part for the satellite2. A specific description of how the base station 1604 divides the data to be transmitted to the terminal 1601 is omitted.

In a step or operation S1622, each of the satellite1 1602 and the satellite2 1603 may transmit the part of the data received from the base station 1604 to the terminal 1601 through its PDSCH. Accordingly, the terminal 1601 may receive the data from the satellite1 1602 and the satellite2 1603. In this case, the data may be transmitted as previously described in FIG. 15A based on a distance between the satellite1 1602 and the terminal 1601 and a distance between the satellite2 1603 and the terminal 1601.

In a step or operation S1630, the terminal 1601 may transmit response signals according to HARQ processes. In other words, the terminal 1601 may transmit HARQ feedbacks. In this case, the HARQ feedbacks transmitted by the terminal 1601 may be transmitted in the methods described above, for example, the methods described in FIGS. 14A and 14B or methods described below.

### Second Embodiment: Transmission of Some HARQ Feedbacks Through a Link with a Smaller Delay

In general, a HARQ stalling phenomenon on a long link with a large transmission delay may be solved by increasing the number of HARQ processes. However, as the number of HARQ processes increases, the complexity of the system increases and the problem of increased latency may be difficult to solve. In addition, a HARQ method without feedbacks on a long link may require data to be transmitted regardless of a channel state. Therefore, to satisfy high reliability requirements of 5G communication, repeated transmission may be required, which inevitably leads to resource wastes.

The method of transmitting all HARQ feedback through a link with a smaller delay (i.e., short link) as in the first embodiment described above may cause a problem of increasing the burden on the short link. Therefore, the above-described problem can be solved by transmitting only some HARQ feedback through the short link. In this case, data for which a feedback is received through the short link may be selected based on importance or urgency of data (e.g., transport block). Specifically, in case of using the scheme of transmitting HARQ feedback information only for some data through the short link, HARQ feedback information only for pre-configured data may be transmitted through the short link, taking into account a priority, urgency, delay sensitivity, etc. of the data.

The number of HARQ processes used for transmitting control information using the short link with respect to the data transmitted using the long link may be indicated through higher layer signaling (e.g., RRC signaling).

This may be as described in more detail, as follows.

First, multiple TRPs may be configured, having a long link with a large delay and a short link with a small delay.

Second, for transmissions through the long link, HARQ process(es) to be used for transmitting a HARQ feedback through the long link or short link may be determined, and then indicated through higher layer signaling (e.g., RRC signaling).

Third, HARQ feedback information may be transmitted through a control channel of the indicated link.

Fourth, as described in more detail below, HARQ process identifiers (IDs) may be reused.

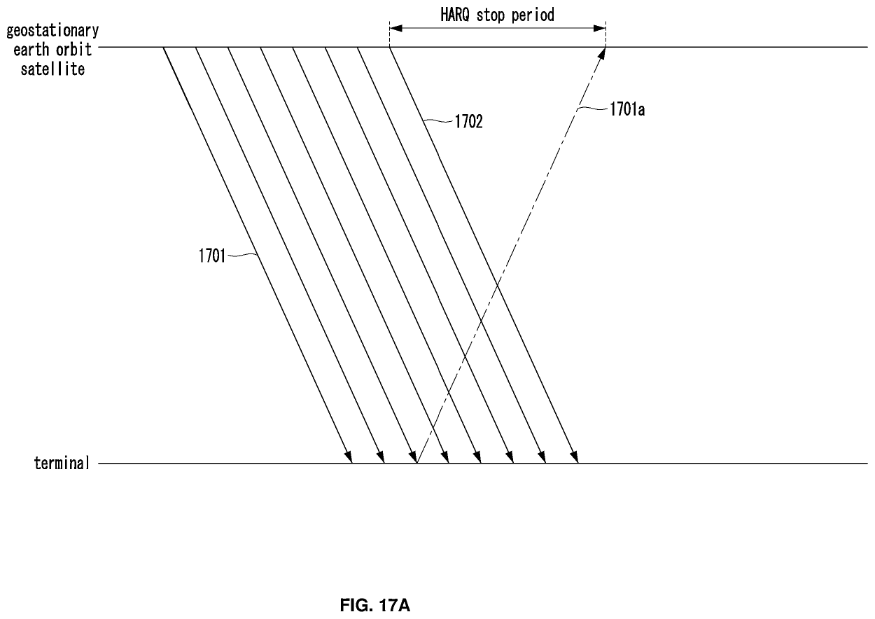

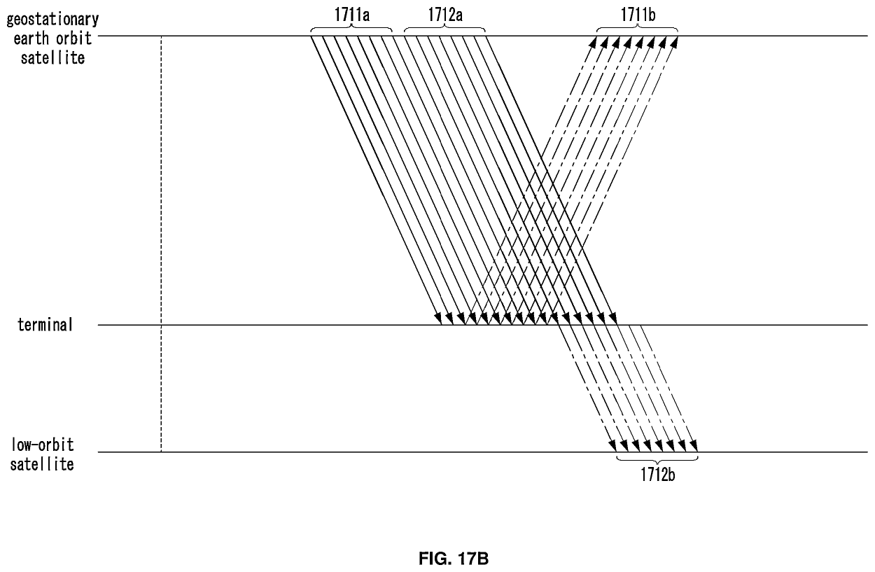

FIG. 17A is a diagram for describing a HARQ stalling phenomenon occurring when signals are received from a satellite with a long link.

In FIG. 17A, a GEO satellite is illustrated as an example of a satellite with a long link. However, this is merely one example, and the satellite with a long link may not necessarily be a GEO satellite. For convenience of description, the following description is made on the assumption that the satellite with a long link is a GEO satellite.

The GEO satellite may transmit a PDSCH to the terminal. When the GEO satellite transmits a first PDSCH 1701 to the terminal, the first PDSCH 1701 may be transmitted by assigning a HARQ process ID. FIG. 17A illustrates a case of using eight HARQ processes. Accordingly, the GEO satellite can transmit PDSCHs to the terminal eight times, and HARQ feedback(s) need to be received while transmitting eight PDSCHs in order for the GEO satellite to transmit PDSCHs again. However, if a distance between the terminal and the satellite is long, as in case of the GEO satellite, HARQ feedback(s) may not be received until all PDSCHs based on the HARQ processes are transmitted.

FIG. 17A illustrates a case where a HARQ feedback cannot be received for a certain time period after all the HARQ processes are exhausted, i.e., a time period equal to a HARQ stop period. If a HARQ feedback cannot be received until at least one HARQ process is released, the GEO satellite cannot transmit the next data to the terminal. Accordingly, a HARQ stalling phenomenon may occur. In FIG. 17A, the HARQ stalling phenomenon is described using a concept of the HARQ stop period.

In embodiment of the present disclosure, feedback paths may be configured differently based on the HARQ processes as a method for solving the above-described problem. This is described in more detail below with reference to FIG. 17B.

FIG. 17B is a timing diagram for describing a case of additionally configuring a HARQ feedback path based on HARQ processes according to an embodiment of the present disclosure.

The two satellites may be satellites in different orbits, as described above, or may be satellites in the same orbit but respectively having a short link and a long link due to different distances from the terminal. However, in the following description, for convenience of description, the satellites are described a low-orbit satellite and a GEO satellites as an example. In addition, it is assumed that the satellites described in the present disclosure are transparent payload-based NTN satellites or bent-pipe satellites that do not process data as described above.

As shown in FIG. 17B, a case where eight HARQ processes exist as in FIG. 17A is illustrated, and a case where the GEO satellite transmits data to the terminal is assumed. In addition, FIG. 17B illustrates a case where different satellites operate as multiple TRPs. In other words, the GEO satellite with a long link may transmit data, and operate with the low-orbit satellite with a short link as multiple TRPs.

According to embodiments of the present disclosure, the GEO satellite or base station (through the GEO satellite) may provide in advance, to the terminal and through a higher layer message (e.g., RRC signaling), information on a timing of transmitting a HARQ feedback to another TRP that is the low-orbit satellite. The information transmitted through RRC signaling may be information indicating to configure a feedback path for the second usage of a specific HARQ process to the low-orbit satellite when the HARQ process is used two times.

As shown in FIG. 17B, based on the eight HARQ processes, the GEO satellite may transmit data to the terminal through PDSCHs on the long link in a step or operation 1711a. Through higher layer signaling, HARQ feedbacks may be configured in advance to be transmitted through the long link for the eight HARQ processes. Accordingly, the terminal may transmit HARQ feedbacks to the GEO satellite with the long link in a step or operation 1711b. Specifically, the terminal may decode data received through the PDSCH from the GEO satellite in the step or operation 1711a, and transmit HARQ feedbacks based on a result of the decoding in the step or operation 1711b.

In addition, after the GEO satellite transmits PDSCHs to the terminal based on the eight HARQ processes in the step or operation 1711a, the GEO satellite may transmit PDSCHs to the terminal by reusing the eight HARQ process in a state in which HARQ feedback(s) for the previously-used eight HARQ processes have not yet been received in a step or operation 1712a. In this case, the terminal may be configured in advance through higher layer signaling to transmit a HARQ feedback through a short link to the satellite2 (i.e., low-orbit satellite) in response to a PDSCH for which the same HARQ process ID is used for the second time.

Therefore, the terminal may transmit the HARQ feedback for data transmitted from the GEO satellite with the same HARQ process ID configured as that in the step or operation 1711a to the low-orbit satellite (1712b). As described above, the terminal may transmit a HARQ feedback according to a specific HARQ process ID to the satellite1 in response to data transmitted from the satellite1 with a long link, and then transmit a HARQ feedback according to the same HARQ process ID to the satellite2 with a short link in response to data transmitted from the GEO satellite, thereby reusing the same HARQ process repeatedly for the two feedback paths. By transmitting the HARQ feedbacks through different links, it may be made possible to distinguish them even when the same HARQ process ID is used. Accordingly, when HARQ feedbacks are transmitted using different links according to the second embodiment of the present disclosure, the HARQ stalling phenomenon can be alleviated. Consequently, the HARQ feedback reception latency may be reduced.

Fifth, both the first method of PUCCH operation and the second method of PUCCH operation described in the first embodiment may be applied in the method of transmitting HARQ feedback information for the long link through a control channel of the short link.

As described above, by alternately transmitting the HARQ feedback information for data of the long link through the long link and the short link for the same HARQ process, the HARQ stalling phenomenon can be alleviated and the latency of receiving the HARQ feedbacks can be reduced. Therefore, the base station may indicate, through higher layer signaling, the terminal to alternately transmit HARQ feedbacks for data of the long link through the long link and the short link in units of the entire HARQ processes.

### Third Embodiment: Retransmission of Data Through a Link with a Smaller Delay in Response to HARQ NACK

The third embodiment of the present disclosure provides a data retransmission method. Retransmission of data may be basically performed through the same link as a link used for initial transmission of the data. In this case, retransmission on a link with a large transmission delay has a problem of further increasing a latency. Therefore, when retransmission is required due to a HARQ negative acknowledgment (NACK), the latency problem can be alleviated by performing retransmission through a short link with a smaller delay according to an embodiment of the present disclosure.

Similarly the ARQ scheme, in the HARQ scheme, received data needs to be stored in a buffer, etc. until retransmission of the entire data succeeds in order to finally receive the data in order. Therefore, when data is retransmitted through a long link, there may occur a problem in that the size of the buffer needs to gradually increase. However, as in embodiments of the present disclosure, the effect of reducing memory capacity can be expected by retransmitting the data through a short link when retransmission occurs due to a HARQ NACK.

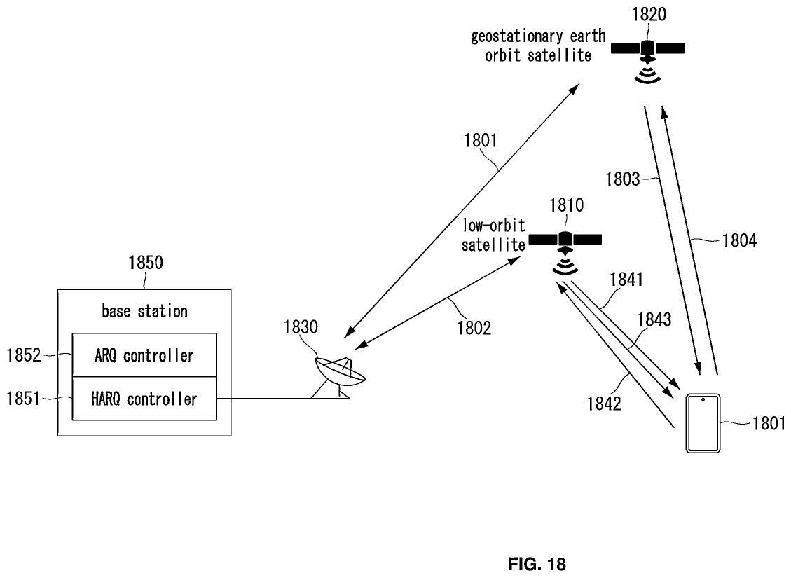

FIG. 18 is a conceptual diagram for describing a retransmission operation due to a HARQ NACK according to a third embodiment of the present disclosure.

In FIG. 18, two different satellites 1810 and 1820 are illustrated. The two different satellites may be satellites in different orbits, as described above, or may be satellites in the same orbit but respectively having a short link and a long link due to different distances from the terminal. However, in the following description, for convenience of description, the satellites are described as a low-orbit satellite 1810 and a GEO satellite 1820 as an example. In addition, it is assumed that the satellites described in the present disclosure are transparent payload-based NTN satellites or bent-pipe satellites that do not process data as described above.

As shown in FIG. 18, a base station 1850 may be connected to the low-orbit satellite 1810 and the GEO satellite 1820 through a gateway 1830. The base station 1850 may include a HARQ controller 1851 and an ARQ controller 1852.

The gateway 1830 may be connected to the GEO satellite 1820 and the low-orbit satellite 1810 through feeder links. Accordingly, the gateway 1830 may transmit data or control information provided by the base station 1850 to the corresponding satellites 1810 and 1820 through the feeder links, respectively.

The low-orbit satellite 1810 may serve as a TRP that performs downlink transmission and uplink reception with the terminal 1801, and the GEO satellite 1820 may also serve as a TRP that performs downlink transmission and uplink reception with the terminal.

Operations according to the third embodiment of the present disclosure are described in more detail below with reference to FIG. 18. In the third embodiment of the present disclosure, retransmission of HARQ retransmission data may be performed through a short link. To this end, a PDSCH may need to be additionally configured for retransmission of data (i.e., data received through the long link) through the short link. The prerequisites and operations for this are as follows.

First, multi-TRP data transmission may be performed through two satellites. Specifically, the GEO satellite 1820 may be configured to transmit data through a PDSCH 1803 configured with the terminal 1801 and the terminal may transmit a HARQ feedback through a PUCCH 1804 configured with the GEO satellite 1820. In addition, the low-orbit satellite 1810 may be configured to transmit data through a PDSCH 1841 configured with the terminal 1801 and the terminal may transmit a HARQ feedback through a PUCCH 1842 configured with the low-orbit satellite 1820.

Second, HARQ feedback information (e.g., ACK/NACK) for data transmitted to the terminal 1801 through a long link (i.e., GEO satellite 1820) may be transmitted based on the method of the first embodiment described above or based on the method of the second embodiment described above.

Third, when a HARQ NACK is received for data transmitted to the terminal 1801 through a long link (i.e., GEO satellite 1820), retransmission data may be transmitted to the terminal through a new second PDSCH 1843 configured on the short link (i.e., low-orbit satellite 1810).

As described above, by transmitting the retransmission data for data received through the long link to the terminal 1801 through the short link, a data waiting time can be reduced and the buffer size of the terminal 1801 can be reduced.

In addition, the third embodiment described above may be operated in combination with the first embodiment and/or the second embodiment as described above.

The operations of methods according to embodiments of the present disclosure can be implemented as a computer readable program, code, or instructions in a computer readable recording medium. The computer readable recording medium may include various kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of an apparatus, the aspects may indicate the corresponding descriptions according to methods, and the blocks or apparatus may correspond to steps or operations of a method or the features of the steps or operations. Similarly, the aspects described in the context of a method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some embodiments, a programmable logic device such as a field-programmable gate array may be used to perform some or all of functions of the methods described herein. In some embodiments, the field-programmable gate array may be operated with a microprocessor to perform one of the methods described herein. In general, the methods are preferably performed by a certain hardware device.

The description of the disclosure is merely illustrative in nature and, thus, variations that do not depart from the substance of the disclosure are intended to be within the scope of the disclosure. Such variations are not to be regarded as a departure from the spirit and scope of the disclosure. Thus, it should be understood by those of ordinary skill in the art that various changes in form and details may be made without departing from the spirit and scope as defined by the following claims.

What is claimed is:

1. A method of a terminal in a non-terrestrial network, the method comprising:
receiving first data through a first link between a first satellite and the terminal;
receiving second data through a second link between a second satellite and the terminal;
determining a long link and a short link based on a first transmission time between the first satellite and the terminal and a second transmission time between the second satellite and the terminal; and
transmitting at least part of hybrid automatic repeat request (HARQ) feedback information corresponding to the long link and HARQ feedback information corresponding to the short link through the short link.

2. The method according to claim 1, wherein the at least part of the HARQ feedback information corresponding to the long link and the HARQ feedback information corresponding to the short link are transmitted on a first physical uplink control channel (PUCCH1) of the short link.

3. The method according to claim 2, wherein the PUCCH1 further includes a field for transmitting the HARQ feedback information corresponding to the short link and an additional field for transmitting the at least part of the HARQ feedback information corresponding to the long link.

4. The method according to claim 3, wherein whether to configure the additional field for transmitting the at least the part of the HARQ feedback information corresponding to the long link is configured in advance by higher layer signaling.

5. The method according to claim 3, further comprising:
transmitting the HARQ feedback information corresponding to the short link through a PUCCH on the short link; and
transmitting the at least part of the HARQ feedback information corresponding to the long link through a preconfigured field in a physical downlink shared channel (PDSCH) on the short link.

6. The method according to claim 1, further comprising:
transmitting the HARQ feedback information corresponding to the short link through a first PUCCH (PUCCH1) on the short link; and
transmitting the at least part of the HARQ feedback information corresponding to the long link through a second PUCCH (PUCCH2) on the short link.

7. The method according to claim 1, wherein the first transmission time is determined based on a round trip delay (RTD) time from the terminal to the first satellite, and the second transmission time is determined based on a RTD time from the terminal to the second satellite.

8. The method according to claim 1, wherein only HARQ feedback(s) corresponding to pre-configured data among the HARQ feedback information corresponding to the long link is transmitted through the short link.

9. The method according to claim 1, further comprising:
receiving higher layer signaling including information indicating to alternately transmit HARQ feedbacks through the long link and the short link in units of entire HARQ processes;
in response to the higher layer signaling, transmitting a HARQ feedback corresponding to a PDSCH received through the long link during one HARQ process through a PUCCH on the long link; and
in response to the higher layer signaling, transmitting a HARQ feedback corresponding to a PDSCH received through the long link during another HARQ process with a same HARQ process identifier as the one HARQ process through a PUCCH on the short link.

10. A terminal in a non-terrestrial network, the terminal comprising:
at least one processor configured to cause the terminal to:
receive first data through a first link between a first satellite and the terminal;
receive second data through a second link between a second satellite and the terminal;
determine a long link and a short link based on a first transmission time between the first satellite and the terminal and a second transmission time between the second satellite and the terminal; and
transmit at least part of hybrid automatic repeat request (HARQ) feedback information corresponding to the long link and HARQ feedback information corresponding to the short link through the short link.

11. The terminal according to claim 10, wherein the at least part of the HARQ feedback information corresponding to the long link and the HARQ feedback information corresponding to the short link are transmitted on a first physical uplink control channel (PUCCH1) of the short link.

12. The terminal according to claim 11, wherein the PUCCH1 further includes a field for transmitting the HARQ feedback information corresponding to the short link and an additional field for transmitting the at least part of the HARQ feedback information corresponding to the long link.

13. The terminal according to claim 12, wherein whether to configure the additional field for transmitting the at least part of the HARQ feedback information corresponding to the long link is configured in advance by higher layer signaling.

14. The terminal according to claim 12, wherein the at least one processor is further configured to causes the terminal to:
transmit the HARQ feedback information corresponding to the short link through a PUCCH on the short link; and
transmit the at least part of the HARQ feedback information corresponding to the long link through a preconfigured field in a physical downlink shared channel (PDSCH) on the short link.

15. The terminal according to claim 10, wherein the at least one processor is further configured to cause the terminal to:
transmit the HARQ feedback information corresponding to the short link through a first PUCCH (PUCCH1) on the short link; and
transmit the at least part of the HARQ feedback information corresponding to the long link through a second PUCCH (PUCCH2) on the short link.

16. The terminal according to claim 10, wherein the first transmission time is determined based on a round trip delay (RTD) time from the terminal to the first satellite, and the second transmission time is determined based on a RTD time from the terminal to the second satellite.

17. The terminal according to claim 10, wherein the at least one processor is further configured to cause the terminal to transmit only HARQ feedback(s) corresponding to pre-configured data among the HARQ feedback information corresponding to the long link through the short link.

18. The terminal according to claim 10, wherein the at least one processor is further configured to cause the terminal to:
receive higher layer signaling including information indicating to alternately transmit HARQ feedbacks through the long link and the short link in units of entire HARQ processes;
in response to the higher layer signaling, transmit a HARQ feedback corresponding to a PDSCH received through the long link during one HARQ process through a PUCCH on the long link; and
in response to the higher layer signaling, transmit a HARQ feedback corresponding to a PDSCH received through the long link during another HARQ process with a same HARQ process identifier as the one HARQ process through a PUCCH on the short link.

19. A method of a base station in a non-terrestrial network, the method comprising:
transmitting higher layer signaling configuring at least part of i) hybrid automatic repeat request (HARQ) feedback information corresponding to a long link and ii) HARQ feedback information corresponding to a short link to be transmitted through the short link among a first link between a first satellite and a terminal and a second link between a second satellite and the terminal;
controlling first data to be transmitted through the first link between the first satellite and the terminal;
controlling second data to be transmitted through the second link between the second satellite and the terminal; and
receiving HARQ feedback information corresponding to the first data and HARQ feedback information corresponding to the second data through a satellite of the short link.

20. The method according to claim 19, wherein the at least part of the HARQ feedback information corresponding to the long link and the HARQ feedback information corresponding to the short link are transmitted on a first physical uplink control channel (PUCCH1) of the short link.
